(19) United States
(12) Patent Application Publication
(10) Pub. No.: US 2026/0179956 A1
(43) Pub. Date: Jun. 25, 2026

(54) POLYMERIC BINDERS FOR ELECTROCHEMICAL CELLS

(71) Applicant: Adden Energy, Inc., Waltham, MA (US)

(72) Inventors: Ri CHEN, Waltham, MA (US); Po-Hsiu CHIEN, Lexington, MA (US); Luhan YE, Boston, MA (US); William FITZHUGH, Watertown, MA (US)

(21) Appl. No.: 19/429,479

(22) Filed: Dec. 22, 2025

Related U.S. Application Data
(60) Provisional application No. 63/738,227, filed on Dec. 23, 2024.

(51) Int. Cl. H01M 4/62; C08F 279/02; H01M 4/04; H01M 4/139

(52) U.S. Cl. CPC H01M 4/622; C08F 279/02; H01M 4/0404; H01M 4/139

(57) ABSTRACT

Embodiments described herein relate to binders including one or more portions, and electrochemical cells including the same. Specifically, in some embodiments, binders may include a first portion, a second portion, and, optionally, a functional portion coupled to at least one of the first portion or the second portion. In some embodiments, the functional portion may also be coupled to first portion. In some embodiments, the second portion is coupled to the first portion in a linear structure, or grafted as a side chain at a predetermined location along a length of the first portion. In some embodiments, the first portion has a first glass transition temperature, and the second portion has a second glass transition temperature. The second glass transition temperature may be greater than the first glass transition temperature.

### CROSS-REFERENCE TO RELATED APPLICATIONS

This application claims priority to and the benefit of U.S. Provisional Patent Application No. 63/738,227, filed on Dec. 23, 2024, and entitled “Polymeric Binders for Electrochemical Cells,” the disclosure of which is hereby incorporated by reference herein in its entirety.

### TECHNICAL FIELD

Embodiments described herein relate to binders for electrochemical cells, such as solid-state electrochemical cells, and electrochemical cells including the same.

### BACKGROUND

Rechargeable electrochemical cells are important for the success of future electronics and electric vehicles (EVs). Such electrochemical cells are generally formed into an electrochemical cell stack by disposing multiple such electrochemical cells on top of each other and disposing the electrochemical cell stack into a housing or can. Solid-state batteries [i.e., electrochemical cells typically having a solid-state electrolyte rather than a liquid electrolyte and/or a conventional separator and electrodes (e.g., anode, cathode)] have emerged as a promising technology for achieving high rate capabilities (e.g., fast charge rates and/or discharge rates) desired by consumers in many end use applications, for example, in EVs. However, the rate capabilities and/or overall performance of solid-state batteries are often limited by conventional binders (e.g., carboxymethyl cellulose (CMC), styrene-butadiene rubber (SBR), poly(acrylic acid) (PAA), etc.), which are often included in one or more components (e.g., electrodes, solid-state electrolyte, etc.) to bind materials together. Conventional binders often require highly polar solvents, which are incompatible with many of the materials used in solid-state batteries (e.g., solid-state electrolyte, lithium metal, etc.), and, if included, may degrade or react with the solid-state electrolyte and/or electrode materials, reduce overall battery performance, and/or pose safety risks. Furthermore, conventional binders often inadequately disperse conductive material in the electrodes, for example, in the casting stage, which may break portions or eliminate sections of conductive networks in the electrodes, to the detriment of rate capabilities and/or overall performance of the cell.

### SUMMARY

Embodiments described herein relate generally to binders including one or more portions, and electrochemical cells including the same. Specifically, in some embodiments, binders may include a first portion, a second portion, and, optionally, a functional portion coupled to at least one of the first portion or the second portion. In some embodiments, the functional portion may be coupled to the second portion. In some embodiments, the functional portion may also be coupled to the first portion. In some embodiments, the second portion can be coupled to the first portion in a linear structure, or grafted as a side chain at a predetermined location along a length of the first portion. In some embodiments, the first portion has a first glass transition temperature, and the second portion has a second glass transition temperature. In some embodiments, the second glass transition temperature may be greater than the first glass transition temperature.

In some embodiments, an electrochemical cell includes: a first electrode disposed on a first current collector; a second electrode disposed on a second current collector, at least one of the first electrode or the second electrode including at least one of an active material or a conductive material; a separator disposed between the first electrode and the second electrode, the separator including a solid-state electrolyte; and a binder included in at least one of the first electrode, the second electrode, or the separator, the binder including: a first portion having a first glass transition temperature; and a second portion coupled to the first portion, the second portion having a second glass transition temperature greater than the first glass transition temperature.

In some embodiments, a binder for an electrochemical cell includes: a first portion having a glass transition temperature of equal to or less than about 0 degrees Celsius; and a second portion coupled to the first portion, the second portion having a glass transition temperature of equal to or greater than about 50 degrees Celsius, wherein the first portion extends linearly, and the second portion extends as a side chain from at least one predetermined location along a length of the first portion.

In some embodiments, a binder for an electrochemical cell includes: a first portion in a range of about 1 wt % to about 99 wt %, the first portion including a first polymer having a glass transition temperature of equal to or less than about 0 degrees Celsius; a second portion in a range of about 1 wt % to about 99 wt % mixed with the first polymer, the second portion including a second polymer having a glass transition temperature of equal to or greater than about 50 degrees Celsius, and aromatic or polyaromatic groups coupled to the second portion.

In some embodiments, a method includes: mixing an active material, a non-polar solvent, and a binder to form a slurry, the binder including: a first portion having a first glass transition temperature, and a second portion coupled to the first portion, the second portion having a second glass transition temperature greater than the first glass transition temperature; disposing the slurry on a conductive substrate; and evaporating at least a portion of the non-polar solvent from the slurry to form an electrode.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a block diagram of a binder including at least one of a first portion or a second portion, and an optional functional portion, according to an embodiment.

FIG. 2 is a block diagram of an electrochemical cell including the binder of FIG. 1, an anode current collector, an anode, a cathode current collector, a cathode, and a separator, according to an embodiment.

FIG. 3 is a schematic illustration of a binder including a linear portion and a functional portion, according to an embodiment.

FIG. 4 is a schematic illustration of a binder including a first portion and a second portion included in a linear structure, and a functional portion coupled to the second portion, according to an embodiment.

FIG. 5 is a schematic illustration of a binder including a first portion and a second portion included in a linear structure, and one or more functional portions coupled to the second portion and optionally coupled to the first portion, according to an embodiment.

FIG. 6 is a schematic illustration of a binder including a plurality of first portions, a plurality of second portions, one or more of the plurality of first portions coupled to one or more of the plurality of second portions in a linear structure, and a plurality of functional portions coupled to the second portions and optionally coupled to the first portions, according to an embodiment.

FIG. 7 is a schematic illustration of a binder including a first portion and a second portion included in a grafted structure, and a functional portion coupled to the second portion, according to an embodiment.

FIG. 8 is a schematic illustration of a binder including a first portion and a second portion included in a grafted structure, and a functional group coupled to the second portion, according to an embodiment.

FIG. 9 is a schematic illustration of a binder including a first portion, a plurality of second portions grafted to the first portion, and one or more functional portions coupled to the second portions and optionally coupled to the first portion, according to an embodiment.

FIG. 10 is a schematic flow chart of a method for preparing an electrochemical cell including a binder, according to an embodiment.

FIG. 11 is a plot of 1H NMR of a binder including 1,2-polybutadiene-graft-polyacrylate with pyrene sidechain, according to an embodiment.

FIG. 12 is a plot of battery cycling of a silicon/graphite composite anode with different binders, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to binders including one or more portions, and electrochemical cells including the same. Specifically, in some embodiments, binders may include a first portion, a second portion, and, optionally, a functional portion coupled to least one of the first portion or the second portion. In some embodiments, the functional portion may be coupled to the second portion. In some embodiments, the functional portion may also be coupled to first portion. In some embodiments, the second portion can be coupled to the first portion in a linear structure, or grafted as a side chain at a predetermined location along a length of the first portion. In some embodiments, the first portion has a first glass transition temperature, and the second portion has a second glass transition temperature. In some embodiments, the second glass transition temperature may be greater than the first glass transition temperature.

Rechargeable electrochemical cells are important to the success of future electronics and electric vehicles (EVs). These electrochemical cells, such as pouch cells, are generally formed into an electrochemical cell stack by disposing multiple such electrochemical cells on top of one another, or side-by-side, and disposing the electrochemical cell stack into a housing or can.

Solid-state batteries typically include electrodes, such as an anode and a cathode, and a solid-state electrolyte as a separator. The anode usually includes graphite, silicon (Si), conductive carbon (i.e., carbon additive), and/or lithium metal. The cathode includes cathode active materials, solid-state electrolyte, and/or conductive carbon. The separator usually includes, or is formed of, solid-state electrolyte, and is disposed between the electrodes (e.g., anode and cathode) to provide isolation of electricity between the electrodes while allowing ionic transport therebetween. For all three components (i.e., cathode, anode, and/or solid-state electrolyte/separator), a binder (e.g., a polymeric binder or binder including a polymer) is usually used to bind materials. The typical method of forming electrodes includes mixing a polymeric binder with the other electrode materials (e.g., anode materials such as graphite, Si, conductive carbon, and/or lithium metal; cathode materials such as cathode active materials, solid-state electrolyte, and/or conductive carbon) in a solvent to form a slurry, cast the slurry onto a current collector, and dry the slurry on the current collector to form the electrode. This may be done for either the anode or the cathode.

The choice of binder can be critical to the performance of solid-state batteries. The binder impacts the dispersion of materials in the slurry, viscosity of the slurry, the binding force between the electrode and its respective current collector, as well as the conductivity in the electrodes and/or separator.

One conventional binder used in cathodes is polyvinylidene fluoride (PVDF). Meanwhile, conventional binders used in anodes include carboxymethyl cellulose (CMC), styrene-butadiene rubber (SBR), and poly(acrylic acid) (PAA). However, each of the conventional cathode or anode binders generally include a highly polar solvent during the mixing process to disperse the materials in the slurry. This poses a significant challenge for solid-state batteries (SSBs) containing solid-state electrolyte and/or lithium metal as such materials are not compatible with high polarity solvents, and they may cause safety issues (e.g., undesired reaction, risk of fires and/or thermal runaway, etc.) and/or degrade performance of the electrochemical cell. Additionally, while conventional binders generally show acceptable interfacial adhesion to Si anode materials, their interaction with hydrophobic conductive carbon materials is often limited and poses the additional challenge of properly dispersing the conductive carbon material in the electrode slurries or mixtures, for example, in anode slurries including Si.

One of the main approaches for dispersing carbon materials in liquid suspensions or solutions has been to use polymers with functional groups configured to bind carbon materials. Polymer structures having a high degree of aromaticity can form a strong π-π interaction with each other, which can bind the polymer structures together at specific distances. This phenomenon may be taken advantage of for the dispersion of graphitic materials in liquid suspensions or solutions. For example, conjugated polymers with many aromatic functional groups (i.e., a high degree of aromaticity) can aid the dispersion of carbon nanotube and graphene in separation and surface functionalization applications. Likewise, polyaromatic functionalities can help disperse polymers in the form of sidechains on non-conjugated polymers. These polymers have the advantage of better compatibility with solvents and additives and highly tunable properties by changing an array of parameters including degree of functionalization, composition, and architecture of the polymer backbone, as well as enabling other functionalities with the incorporation of other functional side chains.

To date, the applications of binders including polymers with aromatic or polyaromatic side chains in batteries have been scarce, and their applications in solid-state batteries have yet to be explored. Moreover, binders merely utilizing polar functionalities may achieve acceptable interaction in certain electrode mixtures, for example, they may provide acceptable interaction with polar surfaces of Si materials included in some anodes. However, their binding towards conductive carbon materials (e.g., graphitic materials) may remain limited due to the hydrophobic nature of such carbon materials. Yet, conductive carbon materials are crucial for effective utilization of electrodes, especially for anodes including Si due to their roles in improving the electronic conductivity of the anode and protecting Si from pulverization.

In contrast, embodiments of the binders (e.g., polymeric binder) described herein that may include a first portion (e.g., soft or rubbery portion), a second portion (e.g., hard or glassy portion), and/or a functional portion (e.g., aromatic or polyaromatic groups), may provide one or more benefits including, for example: (1) improving dispersion of conductive carbon materials in electrode slurries, mixtures, and/or finished electrodes; (2) improving ionic conductivity of the electrodes and/or the solid-state electrolyte (i.e., separator); (3) enabling mixing of electrode slurries with non-polar solvents; (4) eliminating use of highly polar solvents; (5) enhancing the overall performance of solid-state battery/electrochemical cell; (6) improving the stability of the electrode slurries; (7) improving rate capabilities (e.g., charge/discharge rates) for solid-state batteries (e.g., faster charge rates) over those using conventional binders; (8) enabling solid-state batteries to run under 5 C charge conditions, which is difficult or not possible for solid-state batteries using conventional binders; (9) enabling solid-state batteries to run under 0.5 C discharge conditions, which is difficult or not possible for solid-state batteries using conventional binders; (10) protecting Si in anodes from pulverization during mixing; (11) reducing viscosity of electrode slurries; (12) improving manufacturability of the solid-state electrode slurries; (13) improving uniformity of electrode slurries; (14) increasing capacity of solid-state electrochemical cells; (15) reducing amount of side reactions during mixing of slurry, formation of solid-state electrochemical cell, and/or operation of solid-state electrochemical cell; (16) improving the performance of solid-state batteries including conductive carbon materials (e.g., graphitic materials); (17) improving run performance and stability of solid-state batteries under harsh conditions; (18) enabling use of solid-state batteries in applications requiring harsh conditions; (19) improving performance of traditional batteries (e.g., traditional electrochemical cells including a conventional separator); (20) improving casting of anode slurries including silicon; (21) increasing specific capacity of solid-state electrochemical cells; (22) increasing cycle life of solid-state electrochemical cells; and (23) enhancing safety of solid-state electrochemical cells.

As used herein, the term “polymer” refers to a molecule including repeating structural units connected by covalent chemical bonds often characterized by a substantial number of repeating units (e.g., equal to or greater than about 3 repeating units, optionally in some embodiments equal to or greater than about 10 repeating units, optionally in some embodiments equal to or greater than about 30 repeating units) and/or a high molecular weight (e.g., in some embodiments, equal or greater than about 1,000 Da, in some embodiments equal to or greater than about 10,000 Da, optionally, in some embodiments, equal to or greater than about 50,000 Da, in some embodiments, equal to or greater than about 100,000 Da). Polymers are commonly the polymerization product of one or more monomer precursors. The term polymer includes homopolymers, or polymers including a single repeating monomer sub-unit. The term polymer also includes copolymers which are formed when two or more different types of monomers are linked in the same polymer. Copolymers may include two or more monomer subunits, and include random, block, brush, brush block, alternating, segmented, grafted, tapered and other architectures. Useful polymers include organic polymers or inorganic polymers that may be in amorphous, semi-amorphous, crystalline or semi-crystalline states. Cross linked polymers having interconnected chains are useful for some applications.

An “oligomer” refers to a molecule including repeating structural units connected by covalent chemical bonds often characterized by a number of repeating units less than that of a polymer (e.g., in some embodiments, equal to or less than about 20 repeating units) and/or a lower molecular weight (e.g., equal to or less than about 2,000 Da) than polymers. Oligomers may be the polymerization product of one or more monomer precursors.

“Block copolymers” are a type of copolymer including blocks or spatially segregated domains, wherein different domains include different polymerized monomers, for example, including at least two chemically distinguishable blocks. Block copolymers may further include one or more other structural domains, such as ionophobic groups, ionophilic groups, hydrophobic groups, hydrophilic groups, etc. In a block copolymer, adjacent blocks are constitutionally different, i.e., adjacent blocks include constitutional units derived from different species of monomer or from the same species of monomer but with a different composition or sequence distribution of constitutional units. Different blocks (or domains) of a block copolymer may reside on different ends of a polymer (e.g., [A][B]), or may be provided in a selected sequence ([A][B][A][B]).

As used herein, “monomer” refers to a molecule with a relatively low molecular weight (i.e., having a molecular weight less than about 750 Da) and containing one or more polymerizable groups, which are capable of polymerizing and combining with other monomers or oligomers to form other oligomers or polymers.

As used herein, the term “average molecular weight,” refers to number-average molecular weight (Mₙ), unless specified otherwise. Number-average molecular weight is generally defined as the total weight of a sample volume divided by the number of molecules within the sample. In some embodiments, number-average molecular weight of a sample may, for example, be determined and/or defined in accordance with American Society for Testing and Materials (ASTM) standard D 5296-19, dated 2020, which is incorporated herein by reference.

As used herein, the “Glass transition temperature (T_{g})” of a sample may, for example, be determined and/or defined in accordance with International Organization for Standardization (ISO) standard ISO 11357-2:2020, which is incorporated herein by reference.

Embodiments described herein relate to hard-soft copolymer binders that can be used in non-polar solvents. In some embodiments, the hard-soft copolymer binders may include a hard, glassy polymer section (e.g., T_{g}≥50° C.), and a soft, rubbery polymer section (e.g., T_{g}≤0° C.), which may be joined together in a linear or grafted fashion (e.g., attached as a side chain). In some embodiments, the soft section may be non-polar and/or configured to impart flexibility to the binder. In some embodiments, the hard section may include acrylates or (meth)acrylates, and the soft section may include butadienes, isoprenes, and/or siloxanes. Each of the hard section and/or the soft section may include or be homopolymers, copolymers, grafted polymers, or a combination thereof. In some embodiments, functional groups can be added, for example, to improve the anode properties. In some embodiments, the functional groups may include or be aromatic groups or polyaromatic groups, and/or their oligomers. The functional groups may be incorporated as a side chain of the hard-soft copolymer binder. The functional groups may be incorporated randomly or selectively on one of the sections of the binder.

In some embodiments, the hard-soft copolymer binder with aromatic or polyaromatic side chain(s) may improve anode casting. For the polymer, it may include a rubbery (T_{g}≤0° C.), non-polar section that imparts flexibility to the polymer. Non-limiting examples include polybutadiene, polyisoprene, hydrogenated polybutadiene, polydimethylsiloxane or other polymers fit the description. In some embodiments, a hard section (T_{g}≥50° C.) with binding capability for polar Si particles may also be included. This segment may include methacrylate, acrylate, styrene, or their derivatives, or other monomers of similar nature. This section can be either homopolymer or copolymer. The two segments can be joined in a linear or graft fashion. On this polymer, polyaromatic functional groups are incorporated. The functional group can be attached uniformly or selectively to one of the blocks. For polyaromatic groups, a wide array of selections is available. Samples include anthracene, pyrene, biphenyl, thiophene, pentacene, fluorene, triphenylene and the polymers with these as repeating units.

When the polymer binders are synthesized, they may dissolve in a non-polar solvent like toluene, anisole, xylene, and/or isobutyl isobutyrate. Stock solution may then be used for preparing the slurry by mixing with Si, graphite and other active anode materials and conductive additives like conductive carbon and sulfide solid electrolyte. The mixing can be done by using a THINKY™ mixer and additional solvent might be necessary. The resulted slurry may then be casted onto a substrate and dried under vacuum.

The electrochemical cells including the binders of the present disclosure according to an embodiment may exhibit higher specific capacity, higher rate capabilities, longer cycle life, and improved safety over electrochemical cells including traditional binders. The enhanced electrochemical and mechanical properties can contribute to better overall battery performance.

As used herein, the singular forms “a,” “an,” and “the” include plural referents unless the context clearly dictates otherwise. Thus, for example, the term “an electrochemical cell” is intended to mean a single electrochemical cell or a plurality of electrochemical cell, “a material” is intended to mean one or more materials, or a combination thereof.

As used herein, the term “substantially uniform pressure” implies that the pressure applied may vary ±10% across the entire surface or volume being considered. When used in connection with an electrochemical cell, the term “substantially uniform pressure” is intended to convey a pressure variation of equal to or less than 10% across the surface area of an electrochemical cell or an electrochemical cell stack.

As used herein, the term “set,” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other.

As used herein, the term “example” as used herein to describe various embodiments or arrangements is intended to indicate that such embodiments or arrangements are possible examples, representations, and/or illustrations of possible embodiments or arrangements (and such term is not intended to connote that such embodiments or arrangements are necessarily crucial, extraordinary, or superlative examples).

As used herein, the term “including”, “comprising”, or “having”, “containing”, “involving” and variations thereof herein, is meant to encompass the items listed thereafter as well as, optionally, additional items. In the description the same numerical references refer to similar elements. As used in this specification, the terms “about” and “approximately” generally include plus or minus 10% of the value stated. For example, about 5 would include 4.5 to 5.5, approximately 10 would include 9 to 11, and about 100 would include 90 to 110.

As used herein, the term “low shear strength solid” refers to solid materials having a shear strength of no more than about 100 MPa. For example, the low shear strength solid can include aerogels, foams, rubber particles, polymer particles, sand, silica, clay, any other suitable low shear strength solid, carbon particles, or any suitable combination thereof.

As used herein, the term “solid-state electrochemical cell” refers to an electrochemical cell including an anode, a cathode, and a solid-state electrolyte disposed between the anode and the cathode. In some embodiments, the solid-state electrolyte may include a solid-state electrolyte multilayer i.e., at least two layers, e.g., at least three.

As used herein, the term “electrical communication” refers to the juxtaposition of two materials such that the two materials contact each other sufficiently to conduct either an ion or electron current.

As used herein, the term “non-flammable” refers to compounds or compositions which are determined to be nonflammable as determined in accordance with American Society for Testing and Materials (ASTM) standards E-681, dated 2002, which is incorporated herein by reference.

As used herein, the term “non-corrosive” refers to a substance that will not corrode or deteriorate another surface or substance with which it comes into contact through chemical action.

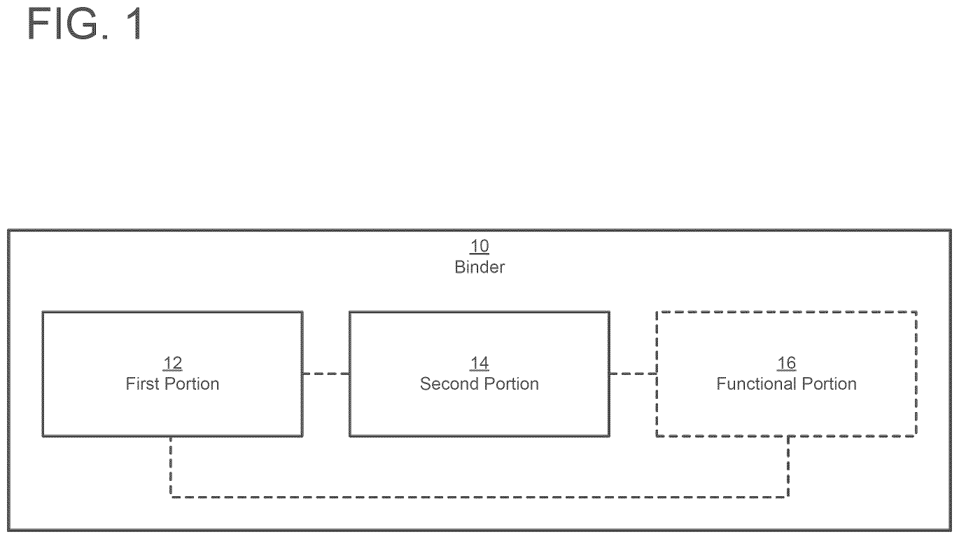

FIG. 1 is a block diagram of a binder 10 for an electrochemical cell (not shown), according to an embodiment. As shown, the binder 10 includes a first portion 12 and a second portion 14. In some embodiments, the second portion 14 may be coupled to the first portion 12. In some embodiments, the binder 10 may optionally include a functional portion 16 coupled to at least one of the first portion 12 or the second portion 14.

In some embodiments, the first portion 12 may include, or be formed of, at least one of a polymer (i.e., polymeric material), an oligomer, a monomer, or a combination thereof. In some embodiments, the first portion 12 may include, or be formed substantially of, a polymer, such as an amorphous polymer. In some embodiments, the first portion 12 may include, or be formed substantially of, a homopolymer, a copolymer, or grafted polymers. In some embodiments, the first portion 12 may be referred to as “rubbery” or “soft.” In some embodiments, the first portion 12 may be configured to impart flexibility to the binder 10. In some embodiments, the first portion 12 may be non-polar. In some embodiments in which the first portion 12 is non-polar, the first portion 12 and/or the binder 10 may be compatible with (i.e., dissolvable in) non-polar solvents. Non-polar solvents may include, but are not limited to, at least one of toluene, anisole, xylene, or isobutyl isobutyrate.

In some embodiments, the first portion 12 may include, or be formed substantially of, at least one of polybutadiene, polybutadiene derivatives, hydrogenated polybutadiene, polyisoprene, polyisoprene derivatives, polydimethylsiloxane, or polydimethylsiloxane derivatives. In some embodiments, the first portion 12 may include at least one of polybutadiene, ethylene-butylene rubber, polyisoprene, hydrogenated polyisoprene, fluororubber, polydimethylsiloxane, or derivatives thereof. In some embodiments, the derivatives of such polymers of the first portion 12 may be from crosslinking, functionalizing with maleic acid, fluorination, oxidation, but are not limited to such approaches. For example, in some embodiments, the polymers of the first portion 12 may be crosslinked, functionalized with maleic acid, fluorinated, or oxidized, and, for example, may generate or include any such derivatives thereof. Hence, the first portion 12 may include any suitable derivatives of any of the above polymers.

In some embodiments, the first portion 12 may have a number-averaged molecular weight (Mₙ) of equal to or greater than about 1,000 Da, where 1 Da is equivalent to 1 gram per mole (g/mol). For example, in some embodiments, the first portion 12 may have an average molecular weight (Mₙ) of at least about 1,000 Da, at least about 5,000 Da, at least about 10,000 Da, at least about 15,000 Da, at least about 20,000 Da, at least about 25,000 Da, at least about 30,000 Da, at least about 35,000 Da, at least about 40,000 Da, at least about 45,000 Da, at least about 50,000 Da, at least about 55,000 Da, at least about 60,000 Da, at least about 65,000 Da, at least about 70,000 Da, at least about 75,000 Da, at least about 80,000 Da, at least about 85,000 Da, at least about 90,000 Da, at least about 95,000 Da, at least about 100,000 Da, at least about 125,000 Da, at least about 150,000 Da, at least about 175,000 Da, at least about 200,000 Da, at least about 225,000 Da, at least about 250,000 Da, at least about 275,000 Da, at least about 300,000 Da, at least about 325,000 Da, at least about 350,000 Da, at least about 375,000 Da, at least about 400,000 Da, at least about 425,000 Da, at least about 450,000 Da, at least about 475,000 Da, at least about 500,000 Da, at least about 525,000 Da, at least about 550,000 Da, at least about 575,000 Da, at least about 600,000 Da, at least about 625,000 Da, at least about 650,000 Da, at least about 675,000 Da, at least about 700,000 Da, at least about 725,000 Da, at least about 750,000 Da, at least about 775,000 Da, at least about 800,000 Da, at least about 825,000 Da, at least about 850,000 Da, at least about 875,000 Da, at least about 900,000 Da, at least about 925,000 Da, at least about 950,000 Da, or at least about 975,000 Da, inclusive.

In some embodiments, the first portion 12 may have an average molecular weight (Mₙ) of equal to or less than about 1,000,000 Da. For example, in some embodiments, the first portion 12 may have an average molecular weight (Mₙ) of no more than about 1,000,000 Da, no more than about 975,000 Da, no more than about 950,000 Da, no more than about 925,000 Da, no more than about 900,000 Da, no more than about 875,000 Da, no more than about 850,000 Da, no more than about 825,000 Da, no more than about 800,000 Da, no more than about 775,000 Da, no more than about 750,000 Da, no more than about 725,000 Da, no more than about 700,000 Da, no more than about 675,000 Da, no more than about 650,000 Da, no more than about 625,000 Da, no more than about 600,000 Da, no more than about 575,000 Da, no more than about 550,000 Da, no more than about 525,000 Da, no more than about 500,000 Da, no more than about 475,000 Da, no more than about 450,000 Da, no more than about 425,000 Da, no more than about 400,000 Da, no more than about 375,000 Da, no more than about 350,000 Da, no more than about 325,000 Da, no more than about 300,000 Da, no more than about 275,000 Da, no more than about 250,000 Da, no more than about 225,000 Da, no more than about 200,000 Da, no more than about 175,000 Da, no more than about 150,000 Da, no more than about 125,000 Da, no more than about 100,000 Da, no more than about 95,000 Da, no more than about 90,000 Da, no more than about 85,000 Da, no more than about 80,000 Da, no more than about 75,000 Da, no more than about 70,000 Da, no more than about 65,000 Da, no more than about 60,000 Da, no more than about 55,000 Da, no more than about 50,000 Da, no more than about 45,000 Da, no more than about 40,000 Da, no more than about 35,000 Da, no more than about 30,000 Da, no more than about 25,000 Da, no more than about 20,000 Da, no more than about 15,000 Da, no more than about 10,000 Da, or no more than about 5,000 Da, inclusive.

Combinations of the above-referenced average molecular weights of the first portion 12 are also possible (e.g., at least about 1,000 Da and no more than about 1,000,000 Da, or at least about 5,000 Da and no more than about 975,000 Da), inclusive of all values and ranges therebetween. For example, in some embodiments, the average molecular weight (Mₙ) of the first portion 12 may be in a range of about 1,000 Da to about 1,000,000 Da, inclusive of all values and ranges therebetween.

In some embodiments, the first portion 12 may have a glass transition temperature (T_{g}) of equal to or less than about 0 degrees Celsius (° C.). In some embodiments, the glass transition temperature of the first portion 12 may be no more than about 0° C., no more than about −10° C., no more than about −20° C., no more than about −30° C., no more than about −40° C., no more than about −50° C., no more than about −60° C., no more than about −70° C., no more than about −80° C., no more than about −90° C., no more than about −100° C., no more than about −110° C., no more than about −120° C., no more than about −130° C., no more than about −140° C., no more than about −150° C., no more than about −160° C., or no more than about −170° C. In some embodiments, the glass transition temperature of the first portion 12 can be at least about −180° C., at least about −170° C., at least about −160° C., at least about −150° C., at least about −140° C., at least about −130° C., at least about −120° C., at least about −110° C., at least about −100° C., at least about −90° C., at least about −80° C., at least about −70° C., at least about −60° C., at least about −50° C., at least about −40° C., at least about −30° C., at least about −20° C., or at least about −10° C. Combinations of the above-referenced glass transition temperatures of the first portion 12 are also possible (e.g., at least about −180° C. and no more than about 0° C., or at least about −150° C. and no more than about −10° C.), inclusive of all values and ranges therebetween. In some embodiments, the first portion 12 can have a glass transition temperature of about 0° C., about −10° C., about −20° C., about −30° C., about −40° C., about −50° C., about −60 ° C., about −70° C., about −80° C., about −90° C., about −100° C., about −110° C., about −120° C., about −130° C., about −140° C., about −150° C., about −160° C., about −170° C., or about −180° C.

In some embodiments, the second portion 14 may include, or be formed of, at least one of a polymer (i.e., a polymeric material), an oligomer, a monomer, or a combination thereof. In some embodiments, the second portion 14 may include, or be formed substantially of, a polymer, such as a crystalline polymer. In some embodiments, the second portion 14 may include, or be formed substantially of, a homopolymer, a copolymer, or grafted polymers. In some embodiments, the second portion 14 may include, or be formed of a polymer, oligomer, monomer, or combination thereof that is different than the polymer, oligomer, or monomer of the first portion 12. For example, in some embodiments, the first portion 12 may include, may be, or may be formed substantially of, a first polymer. In some embodiments, the second portion 14 may include, may be, or may be formed substantially of a second polymer. In some embodiments, the second polymer may be different from the first polymer. In some embodiments, the second portion 14 may be referred to as “glassy” or “hard.” In some embodiments, the second portion 14 may be configured to impart binding capability to the binder 10. In some embodiments, the second portion 14 may be configured to enable functionalization of the binder 10. In some embodiments, the second portion 14 may be polar.

In some embodiments, the second portion 14 (or the second polymer) may include, or be formed substantially of, at least one of polymethacrylate, polyacrylate, polystyrene, or polystyrene derivatives. In some embodiments, the second portion 14 may include at least one of poly(tert-butyl acrylate), poly(hexafluoro butyl acrylate), poly(acrylic acid), poly(sodium acrylate), poly(lithium acrylate), poly(adamantly acrylate), poly(benzyl acrylate), poly(methyl methacrylate), poly(hexafluoro methacrylate), poly(methacrylic acid), poly(sodium methacrylate), poly(isobutyl methacrylate), poly(benzyl methacrylate), poly(polyethylene glycol methacrylate), poly(polydimethylsiloxane methacrylate), poly(alpha-isobromobutyl methacrylate, polystyrene, polystyrene sulfonate, poly(p-tert butyl styrene), poly(4-vinyl pyridine), or poly(vinyl phenol).

In some embodiments, the second portion 14 may have an average molecular weight (Mₙ) of equal to or greater than about 1,000 Da, where 1 Da is equivalent to 1 gram per mole (g/mol). For example, in some embodiments, the second portion 14 may have an average molecular weight (Mₙ) of at least about 1,000 Da, at least about 5,000 Da, at least about 10,000 Da, at least about 15,000 Da, at least about 20,000 Da, at least about 25,000 Da, at least about 30,000 Da, at least about 35,000 Da, at least about 40,000 Da, at least about 45,000 Da, at least about 50,000 Da, at least about 55,000 Da, at least about 60,000 Da, at least about 65,000 Da, at least about 70,000 Da, at least about 75,000 Da, at least about 80,000 Da, at least about 85,000 Da, at least about 90,000 Da, at least about 95,000 Da, at least about 100,000 Da, at least about 125,000 Da, at least about 150,000 Da, at least about 175,000 Da, at least about 200,000 Da, at least about 225,000 Da, at least about 250,000 Da, at least about 275,000 Da, at least about 300,000 Da, at least about 325,000 Da, at least about 350,000 Da, at least about 375,000 Da, at least about 400,000 Da, at least about 425,000 Da, at least about 450,000 Da, at least about 475,000 Da, at least about 500,000 Da, at least about 525,000 Da, at least about 550,000 Da, at least about 575,000 Da, at least about 600,000 Da, at least about 625,000 Da, at least about 650,000 Da, at least about 675,000 Da, at least about 700,000 Da, at least about 725,000 Da, at least about 750,000 Da, at least about 775,000 Da, at least about 800,000 Da, at least about 825,000 Da, at least about 850,000 Da, at least about 875,000 Da, at least about 900,000 Da, at least about 925,000 Da, at least about 950,000 Da, or at least about 975,000 Da, inclusive.

In some embodiments, the second portion 14 may have an average molecular weight (Mₙ) of equal to or less than about 1,000,000 Da. For example, in some embodiments, the second portion 14 may have an average molecular weight (Mₙ) of no more than about 1,000,000 Da, no more than about 975,000 Da, no more than about 950,000 Da, no more than about 925,000 Da, no more than about 900,000 Da, no more than about 875,000 Da, no more than about 850,000 Da, no more than about 825,000 Da, no more than about 800,000 Da, no more than about 775,000 Da, no more than about 750,000 Da, no more than about 725,000 Da, no more than about 700,000 Da, no more than about 675,000 Da, no more than about 650,000 Da, no more than about 625,000 Da, no more than about 600,000 Da, no more than about 575,000 Da, no more than about 550,000 Da, no more than about 525,000 Da, no more than about 500,000 Da, no more than about 475,000 Da, no more than about 450,000 Da, no more than about 425,000 Da, no more than about 400,000 Da, no more than about 375,000 Da, no more than about 350,000 Da, no more than about 325,000 Da, no more than about 300,000 Da, no more than about 275,000 Da, no more than about 250,000 Da, no more than about 225,000 Da, no more than about 200,000 Da, no more than about 175,000 Da, no more than about 150,000 Da, no more than about 125,000 Da, no more than about 100,000 Da, no more than about 95,000 Da, no more than about 90,000 Da, no more than about 85,000 Da, no more than about 80,000 Da, no more than about 75,000 Da, no more than about 70,000 Da, no more than about 65,000 Da, no more than about 60,000 Da, no more than about 55,000 Da, no more than about 50,000 Da, no more than about 45,000 Da, no more than about 40,000 Da, no more than about 35,000 Da, no more than about 30,000 Da, no more than about 25,000 Da, no more than about 20,000 Da, no more than about 15,000 Da, no more than about 10,000 Da, or no more than about 5,000 Da, inclusive.

Combinations of the above-referenced average molecular weights of the second portion 14 are also possible (e.g., at least about 1,000 Da and no more than about 1,000,000 Da, or at least about 5,000 Da and no more than about 975,000 Da), inclusive of all values and ranges therebetween. For example, in some embodiments, the average molecular weight (Mₙ) of the second portion 14 may be in a range of about 1,000 Da to about 1,000,000 Da, inclusive of all values and ranges therebetween.

In some embodiments, the second portion 14 may have a glass transition temperature (T_{g}) of equal to or greater than about 50° C. In some embodiments, the glass transition temperature of the second portion 14 may be at least about 50° C., at least about 60° C., at least about 70° C., at least about 80° C., at least about 90° C., at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., at least about 220° C., at least about 230° C., at least about 240° C., at least about 250° C., at least about 260° C., at least about 270° C., at least about 280° C., at least about 290° C., at least about 300° C., at least about 310° C., at least about 320° C., at least about 330° C., or at least about 340° C. In some embodiments, the glass transition temperature of the second portion 14 may be no more than about 350° C., no more than about 340° C., no more than about 330° C., no more than about 320° C., no more than about 310° C., no more than about 300° C., no more than about 290° C., no more than about 280° C., no more than about 270° C., no more than about 260° C., no more than about 250° C., no more than about 240° C., no more than about 230° C., no more than about 220° C., no more than about 210° C., no more than about 200° C., no more than about 190° C., no more than about 180° C., no more than about 170° C., no more than about 160° C., no more than about 150° C., no more than about 140° C., no more than about 130° C., no more than about 120° C., no more than about 110° C., no more than about 100° C., no more than about 90° C., no more than about 80° C., no more than about 70° C., or no more than about 60° C. Combinations of the above-referenced glass transition temperatures of the second portion 14 are also possible (e.g., at least about 50° C. and no more than about 350° C., or at least about 60° C. and no more than about 340° C.), inclusive of all values and ranges therebetween. In some embodiments, the second portion 14 can have a glass transition temperature of about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., about 250° C., about 260° C., about 270° C., about 280° C., about 290° C., about 300° C., about 310° C., about 320° C., about 330° C., about 340° C., or about 350° C.

In some embodiments, the glass transition temperature of the first portion 12 may be a first glass transition temperature, and the glass transition temperature of the second portion 14 may be a second glass transition temperature. In some embodiments, the second glass transition temperature (i.e., the T_{g} of the second portion 14) may be different from the first glass transition temperature (i.e., the T_{g} of the first portion 12). In some embodiments, the second glass transition temperature (i.e., T_{g} of the second portion 14) may be greater than the first glass transition temperature (i.e., T_{g} of the first portion 12).

In some embodiments, the first portion 12 and the second portion 14 may be disposed in a mixture without substantial binding between the two portions. In some embodiments, the first portion 12 and the second portion 14 may be coupled together. For example, in some embodiments, an axial end of the first portion 12 may be coupled (e.g., bonded, covalently bonded) to an axial end of the second portion 14, for example, to form a linear structure or chain. In such embodiments, the binder 10 may be include or be formed of a linear copolymer. In some embodiments, the linear copolymer may include or be formed of the first portion 12 and the second portion 14. In some embodiments, the linear copolymer may be formed of a plurality of first portions and/or a plurality of second portions. In some embodiments, the plurality of first portions may be substantially similar to, or the same as, the first portion 12, and, hence, may be referred to herein as “first portion(s) 12.” In some embodiments, the plurality of the second portions may be substantially similar to, or the same as, the second portion 14, and, hence, may be referred to herein as “second portion(s) 14.”

In some embodiments, the binder 10 may include, or be formed substantially of, linear polymers and/or linear copolymers, the linear polymer or linear copolymer(s) having a linear structure including a main chain (i.e., main polymer chain or “polymer backbone”). In some embodiments, the first portion(s) 12 and/or the second portion(s) 14 may each include, or be formed substantially of, homopolymers or copolymers, each of which may be linear. In some embodiments, the linear copolymer(s) may include the first portion(s) 12 and/or the second portion(s) 14. For example, the first portion(s) 12 and the second portion(s) may be disposed in, incorporated in, or may substantially form, the main chain of the linear copolymer. As previously described, in some embodiments, the first portion(s) 12 may include, may be, or may be formed substantially of, the first polymer, and the second portion(s) 14 may include, may be, or may be formed substantially of, the second polymer. In some embodiments, the second polymer may be different from the first polymer. In some embodiments, the binder 10 may include at least one of alternating copolymers including the first portion(s) 12 and the second portion(s) 14, random or statistical copolymers including the first portion(s) 12 and the second portion(s) 14, or block copolymers including, or formed substantially of, the first portion(s) 12 and the second portion(s) 14.

For example, in some embodiments, the first portion(s) 12 and the second portion(s) 14 may be alternating with one another in the main chain. In some embodiments, the first portion(s) 12 and the second portion(s) 14 may be disposed randomly or statistically in the main chain. In some embodiments, a plurality of the first polymers may be coupled together in the first portion 12 such that the first portion 12 may form a first block, and a plurality of the second polymers may be coupled together in the second portion 14 such that the second portion 14 forms a second block. In some embodiments, the first portion(s) 14 (i.e., first block) and the second portion(s) 14 (i.e., second block(s)) may form a block copolymer, for example the main polymer chain of the block copolymer. Likewise, in some embodiments, the plurality of first portion(s) 12 may be coupled together to form a first block of first portion(s) 12 and/or the plurality of second portion(s) 14 may be coupled together to form a second block of second portion(s) 14, and the first block and second block may be disposed in the main polymer chain to form the block copolymer. The binder 10 including, or formed substantially of, the linear polymer or linear copolymers may be referred to as “linear copolymeric binder 10.”

In some embodiments, the binder 10 may include, or be formed substantially of, branched polymers or branched copolymers. The branched polymers or branched copolymers may include the main chain (i.e., main polymer chain or “polymer backbone”) with one or more side chains (e.g., polymeric side chains) extending therefrom. The branched polymers or branched copolymers may include the first portion(s) 12 and/or the second portion(s) 14. For example, at least one of the first portion(s) 12 or the second portion(s) may be disposed in, incorporated in, or may substantially form the main chain of the branched polymer or branched copolymer. Likewise, in some embodiments, at least one of the first portion(s) 12 or the second portion(s) 14 may be disposed in, incorporated in, or may substantially form the one or more side chains extending from the main chain. In some embodiments, the first portion(s) 12 may extend linearly, and the second portion(s) 14 may extend as the side chain(s) from the first portion(s) 12. For example, in some embodiments, the second portion 14 may be grafted as the side chain to the first portion 12 to form a grafted structure. In some embodiments, the first portion(s) 12 may form the main chain or backbone, and the second portion(s) 14 may be grafted to the first portion(s) 12 as one or more side chains. In some embodiments, the binder 10 including, or formed substantially of, the branched polymers or branched copolymers may be referred to as “branched copolymeric binder 10” or “grafted copolymeric binder 10.”

In some embodiments, the functional portion 16 may include, or be formed substantially of, at least one of an aromatic group or polyaromatic group. In some embodiments, the functional portion 16 can include, or be formed substantially of, at least one of thiophene, thiophene derivatives, biphenyl, biphenyl derivatives, anthracene, anthracene derivatives, fluorene, fluorene derivatives, pyrene, pyrene derivatives, triphenylene, triphenylene derivatives, carbazole, carbazole derivatives, pentacene, or pentacene derivatives. In some embodiments, the aromatic group or polyaromatic group can include or be at least one of thiophene, thiophene derivatives, biphenyl, biphenyl derivatives, anthracene, anthracene derivatives, fluorene, fluorene derivatives, pyrene, pyrene derivatives, triphenylene, triphenylene derivatives, carbazole, carbazole derivatives, pentacene, or pentacene derivatives.

In some embodiments, the functional portion 16 may include one or more aromatic group(s) or polyaromatic group(s). For example, in some embodiments, the functional portion 16 may include a plurality of aromatic groups or polyaromatic groups, each of which may be coupled (e.g., bonded, covalently bonded) together. In some embodiments, the functional portion 16 may include thiophene, thiophene derivatives, biphenyl, biphenyl derivatives, anthracene, anthracene derivatives, fluorene, fluorene derivatives, pyrene, pyrene derivatives, triphenylene, triphenylene derivatives, carbazole, carbazole derivatives, pentacene, pentacene derivatives, or a combination thereof.

In some embodiments, the functional portion 16 can be coupled to at least one of the first portion 12 or the second portion 14. For example, in some embodiments, the functional portion 16 may be coupled to the first portion 12. In some embodiments, the functional portion 16 may be coupled to the second portion 14. In some embodiments, the functional portion 16 may be coupled only to the second portion 14. In some embodiments, the functional portion 16 may be coupled at a predetermined position along a length of the first portion 12 or the second portion 14.

In some embodiments, the binder 10 may include one or more functional portion(s). For example, in some embodiments, the binder may include a plurality of functional portions. In some embodiments, the plurality of functional portions may be substantially similar to, or the same as, the functional portion 16, and, hence, may be referred to herein as “functional portion(s) 16.”

In some embodiments, the functional portion(s) 16 may be coupled (e.g., bonded, covalently bonded) to at least one of the second portion(s) 14 or the first portion(s) 12. In some embodiments, the functional portion(s) 16 may be coupled to one or more of the first portion(s) 12. For example, in some embodiments, a plurality of functional portions 16 may be coupled to one or more of the first portion(s) 12. In some embodiments, the functional portion(s) 16 may be coupled to one or more of the second portion(s) 14. In some embodiments, a plurality of functional portions 16 may be coupled to one or more of the second portion(s) 14. In some embodiments, the functional portion(s) 16 may be coupled to a combination of the first portion(s) 12 and the second portion(s) 14. In some embodiments, the functional portion(s) 16 may be coupled only to the second portion(s) 14.

In some embodiments in which the binder 10 is the linear copolymeric binder 10, the functional portion(s) 16 may extend as one or more side groups from the first portion(s) 12 or the second portion(s) 14. In some embodiments, the functional portion(s) 16 may extend as the one or more side groups from only the second portion(s) 14.

In some embodiments in which the binder 10 is the grafted copolymeric binder 10 including the first portion(s) 12 as the main chain and the second portion(s) 14 as one or more side chains, the functional portion(s) 16 may extend as one or more side groups from at least one of the first portion(s) 12 or the second portion(s) 14. In some embodiments, the functional portion(s) 16 may extend as the one or more side groups from only the second portion(s) 14 (i.e., only from the side chains).

As previously described, in some embodiments, the binder 10 can be compatible (i.e., dissolvable, mixable) in non-polar solvents. For example, in some embodiments, the first portion 12 which may include a soft, rubbery polymer section having a low T_{g} (e.g., T_{g}≤0° C.), and the second portion 14 portion may include a hard, glassy polymer section having a high T_{g} (e.g., T_{g}≥50° C.). As previously described, the first portion 12 and the second portion 14 may be joined together in a linear structure, or a grafted structure. In some embodiments, the first portion 12 may be substantially non-polar. Without being bound by theory, in some embodiments in which the first portion 12 of the binder 10 is non-polar, the binder 10 may be compatible with (e.g., dissolved in, mixed in, etc.) non-polar solvents such that binder 10 may be incorporated in mixtures or slurries including lithium metal and/or solid-state electrolytes, for example, without adverse effects (e.g., side reactions, safety issues, poor mixing or dispersion). Lithium metal and/or solid-state electrolyte materials (e.g., anode) are generally incompatible with polar solvents, which may lead to undesirable side reactions, safety issues, or poor mixing or dispersion when combined, for example, in electrode slurries and/or solid-state electrolyte slurries for electrochemical cells. Therefore, in some embodiments, it may be advantageous to include the binder 10 in the electrode slurries and/or solid-state electrolyte slurries to promote better mixing or dispersion of the electrode materials or solid-state electrolyte materials while reducing or eliminating the risk of undesired side reactions or other safety issues.

When the binder 10 is synthesized, it may be dissolved in a non-polar solvent to form a stock solution. The non-polar solvent may include at least one of toluene, anisole, xylene, or isobutyl isobutyrate. The stock solution may be used for preparing electrode slurries, for example, by mixing with Si, graphite and other active anode or cathode materials and conductive additives like conductive carbon and sulfide solid electrolyte to form an anode slurry. The mixing may be performed by any suitable mixer, such as a THINKY™ mixer. Additional non-polar solvent(s) might be added to the anode slurry, for example, to modify a viscosity of the slurry. The anode slurry may then be casted onto a substrate (e.g., a current collector) and dried under vacuum to form an anode.

In some embodiments, including the functional portion 16 in the binder 10 may improve electrochemical properties of the binder and thereby, components of the electrochemical cell in which the binder is included, such as improved anode properties. In some embodiments, the functional portion 16 may include aromatic groups or polyaromatic groups, or their oligomers. In some embodiments, the functional portion 16 may be incorporated as a side chain of the binder 10. In some embodiments, the functional groups 16 may be incorporated randomly or selectively on at least one of the sections of the binder 10 (e.g., the first portion 12 or the second portion 14).

In some embodiments, the binder 10 including the functional portion 16, for example, including aromatic or polyaromatic side chain(s), may improve anode casting. For functional portion 16, the polyaromatic groups, a wide array of aromatic groups or polyaromatic groups are available. Samples include anthracene, pyrene, biphenyl, thiophene, pentacene, fluorene, triphenylene and the polymers with these as repeating units. Without being bound by theory, the binder 10 having structures with a high degree of aromaticity can form a strong n-a interaction with each other. This phenomenon may be used to better disperse conductive materials (e.g., carbon, carbonaceous materials, graphitic materials, carbon nanotubes, graphene) in solutions or slurries. The functional portion 16 including polyaromatic functionalities may also help disperse polymers in the form of sidechains on non-conjugated polymers. These polymers have the advantage of better compatibility with solvents and additives and highly tunable properties by changing an array of parameters including degree of functionalization, composition and architecture of the polymer backbone as well as incorporating other functionalities by introducing other functional side chains.

In some embodiments, the binder 10 may be incorporated into an electrochemical cell, such as a solid-state electrochemical cell (i.e., solid-state battery) or one or more components thereof (e.g., an anode, a cathode, or a separator, such as a separator including a solid-state electrolyte). In some embodiments, electrochemical cells including the binder 10 may exhibit higher specific capacity, higher rate capabilities, longer cycle life, and improved safety over electrochemical cells including traditional binders. The enhanced electrochemical and mechanical properties can contribute to better overall electrochemical cell performance.

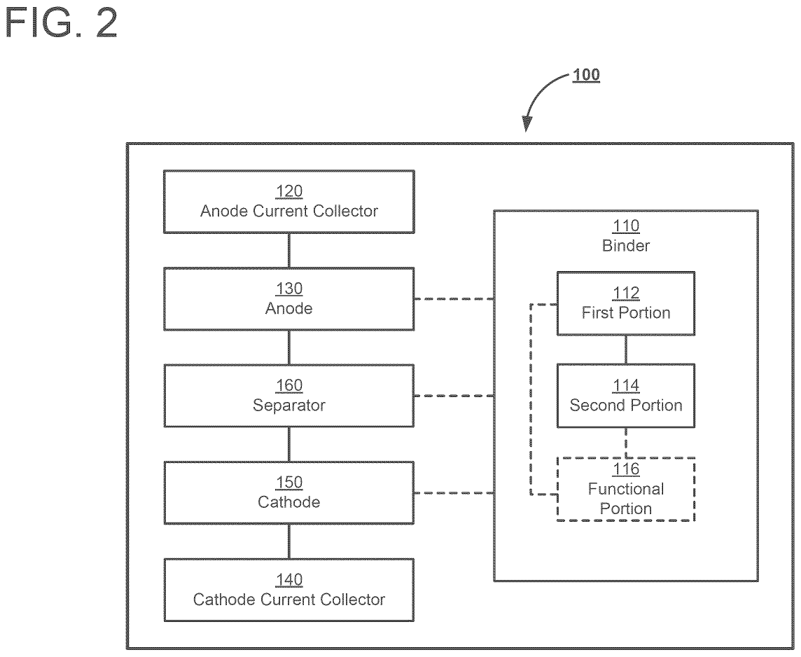

FIG. 2 is a schematic block diagram of an electrochemical cell 100, according to an embodiment. As shown in FIG. 2, the electrochemical cell 100 includes a binder 110. In some embodiments, the binder 110 can include a first portion 112 and a second portion 114. In some embodiments, the binder 110 can further include a functional portion 116. In some embodiments, the functional portion 116 can be coupled to at least one of the first portion 112 or the second portion 114. In some embodiments, the electrochemical cell 100 further includes an anode 130 disposed on an anode current collector 120, a cathode 150 disposed on a cathode current collector 140, and a separator 160 disposed between the anode 130 and the cathode 150. In some embodiments, the separator 160 may include a solid-state electrolyte.

In some embodiments, the binder 110, the first portion 112, the second portion 114, and the functional portion 116 can be the same, or substantially similar to the binder 10, the first portion 12, the second portion 14, and the functional portion 16, respectively, as described with respect to FIG. 1. Therefore, certain features of the binder 110, the first portion 112, the second portion 114, and/or the functional portion 116 are not described in further detail herein.

In some embodiments, the anode 130, the anode current collector 120, the cathode 150, the cathode current collector 140 and the separator 160 can be disposed in a pouch (not shown), for example, an aluminum pouch, a mica pouch, a polymer pouch, etc. In some embodiments, the anode 130, the anode current collector 120, the cathode 150, the cathode current collector 140, and the separator 160 can be disposed in a prismatic cell (not shown).

The anode 130 includes an anode active material. In some embodiments, the anode 130 can include a conductive material, such as an anode conductive material. In some embodiments, the anode 130 can include a solid anode. In some embodiments, the anode 130 is disposed on the anode current collector 120, and is configured to receive electrons therefrom. In some embodiments, the anode current collector 120 includes copper, aluminum, nickel, titanium, or any combination thereof.

In some embodiments, the anode 130 can have a thickness in a range of about 0 μm to about 1000 μm, inclusive. For example, the anode 130 may have a thickness in a range of about 0 μm to about 500 μm, about 0 μm to about 100 μm, about 10 μm to about 1000 μm, about 10 μm to about 500 μm, about 10 μm to about 100 μm, about 100 μm to about 1000 μm, or about 100 μm to about 500 μm, inclusive. The thickness of “0 μm” may be interpreted the anode 130 having no thickness or as the anode 130 being excluded from the electrochemical cell 100. In other words, in some embodiments, the electrochemical cell 100 can include an anode-free design.

In some embodiments, the anode 130 can include at least one of Li, Na, Mg, Al, Si, K, Ca, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, Te, or a combination thereof (e.g., as an alloy). In some embodiments, the anode 130 can include Li metal or Na metal. In some embodiments, the conductive material included in anode 130 can include carbon or a carbonaceous material. In some embodiments, the conductive material or the carbon can include at least one of graphite, hard carbon, amorphous carbon, carbon nanotube, graphene, carbon nanofiber, or a fullerene. In some embodiments, the anode 130 can further include a protective layer (not shown) including at least one of Li, Na, Mg, Al, Si, K, Ca, C, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, Te, or a combination thereof.

In some embodiments, the anode 130 can include Na and a protective layer or coating disposed thereon. The protective layer or coating may include at least one of graphite, silicon, silicon dioxide, Na₄Ti₅O₁₂, Na₃V₂O₅, Au, Ag, Sn, SnO₂, carbon (e.g., amorphous carbon, carbon nanotube, graphene, carbon nanofiber, fullerenes (e.g., C₆₀ fullerene), hard carbon, or graphite), Na, a mixture of Na with a polymer, a polymer, or combination thereof.

In some embodiments, the anode 130 can include Li and a protective layer or coating including at least one of silicon, silicon dioxide, Li₄Ti₅O₁₂, Li₃V₂O₅, carbon (e.g., amorphous carbon, carbon nanotube, graphene, carbon nanofiber, fullerenes (e.g., C₆₀ fullerene), hard carbon, or graphite), Au, Ag, Sn, SnO₂, Li, a mixture of Li with a polymer, a polymer, or a combination thereof.

The cathode 150 includes a cathode active material. In some embodiments, the cathode 150 can include a conductive material, such as a cathode conductive material. In some embodiments, the cathode active material may be mixed with a polymer, carbon or a combination thereof. Examples of polymers that may be mixed with the cathode active material may include, but not limited to, polyethylene oxide, polyvinylidene fluoride, poly(vinylidene fluoride-co-hexafluoropropylene), poly(ethyl methacrylate), or poly(vinylidene fluoride-co-trifluoroethylene). In some embodiments, the cathode 150 can include, or be, a solid cathode. In some embodiments, the cathode 150 is disposed on the cathode current collector 140, and is configured to communicate electrons thereto. In some embodiments, the cathode current collector 140 can include aluminum, stainless steel or any other suitable current collector material.

In some embodiments, the cathode 150 can include at least one of LiNi_{0.8}Mn_{0.1}Co_{0.1}O₂ (NMC811), LiNi_{0.33}Mn_{0.33}Co_{0.33}O₂ (NMC111), LiNi_{0.5}Mn_{0.3}Co_{0.2}O₂ (NMC532), LiNi_{0.6}Mn_{0.2}Co_{0.2}O₂ (NMC622), LiNi_{0.9}Mn_{0.05}Co_{0.05}O₂ (NMC955), LiNiₓMn_{y}Co_{(1-x-y)}O₂ (0≤x, y≤1), LiNiₓCo_{y}Al_{(1-x-y)}O₂ (0≤x, y≤1), LiMn₂O₄, LiMnO₂, LiNiO₂, Li_{1+z}NiₓMn_{y}Co_{(1-x-y-z})O₂ (0≤x, y, z≤1), Li_{1+z}NiₓMn_{y}Co_{w}Al_{(1-x-y-z-s)}O₂ (0≤x, y, z, s≤1), Li_{1+z}NiₓMn_{y}CoₛW_{(1-x-y-z-s)}O₂ (0≤x, y, z, w≤1), V₂O₅, selenium, sulfur, selenium-sulfur compound, LiCoO₂ (LCO), LiFePO₄, LiNi_{0.5}Mn_{1.5}O₄, Li₂CoPO₄F, LiNiPO₄, Li₂Ni(PO₄)F, LiMnF₄, LiFeF₄, or LiCo_{0.5}Mn_{1.5}O₄. In some embodiments, the cathode 150 can be coated with a protective layer including at least one of LiNbO₃, LiTaO₃ Li₂ZrO₃, LiNbₓTa₁₋ₓO₃ (0≤x≤1), yLi₂ZrO₃—(1−y)LiNbxTa₁₋ₓO₃ (0≤x, y≤1), Al₂O₃, TiO₂, ZrO₂, AlF₃, MgF₂, SiO₂, ZnS, ZnO, Li₄SiO₄ Li₃PO₄, Li₃InCl₆, Li₁₊ₓAlₓTi₂₋ₓ(PO₄)₃ (0<x<2), LiMn₂O₄, LiInO₂-LiI, Li₆PS₅Cl, LiAlO₂, a polymer, or carbon.

In some embodiments, the cathode 150 can include at least one of Na_{w}MnO₂, Na_{w}CoO₂, Na_{w}NiO₂, Na_{w}TiO₂, Na_{w}VO₂, Na_{w}CrO₂, Na_{w}FeO₂, Na_{w}(MnₓFe_{y}CO_{z}Ni_{1-x-y-z})O₂ (0≤x, y, z≤1), Na_{w}(M)PO₄, Na_{w}(M)P₂O₇, Na_{w}(M)O₂, or NaₓM_{y}(XO₄)_{z}, where M is a metal element or a combination of metal elements, e.g., transition metal elements; where X is B, S, P, Si, As, Mo, W, or a combination thereof; where 0≤x, y, z≤3; 0<w≤1; and where O can be partially replaced by F, Cl, Br, or I. In some embodiments, the cathode 150 can be coated with a protective layer including at least one of NaNbO₃, NaTaO₃, Na₂ZrO₃, NaNbₓTa₁₋ₓO₃ (0≤x≤1), yNa₂ZrO₃—(1−y)NaNbxTa₁₋ₓO₃ (0≤x, y≤1), Al₂O₃, TiO₂, ZrO₂, AlF₃, MgF₂, SiO₂, ZnS, ZnO, Na₄SiO₄, Na₃PO₄, Na₃InCl₆, Na₁₊ₓAIₓTi₂₋ₓ(PO₄)₃ (0<x<2), NaMn₂O₄, NaInO₂—Nal, Na₆PS₅Cl, NaAlO₂, or carbon.

In some embodiments, the protective layers can be used to coat anode 130, the cathode 150, or a combination thereof. The protective layers may enhance the safety and performance of the battery by preventing the contact between the electrolyte, e.g., solid electrolyte, and other battery components. The composition of protective layers varies according to the composition of the anode 130, the cathode 150 or combination thereof.

In some embodiments, the protective layer includes particles. In some embodiments, the particles have a particles size (i.e., average particle size) in a range of about 1 nm to about 100 μm, inclusive of all values and ranges therebetween. For example, in some embodiments, the particles may have a particle size in a range of about 1 nm to about 100 nm, inclusive of all values and ranges therebetween (e.g., ranges including about 1-10 nm, 1-25 nm, 10-20 nm, 20-30 nm, 25-50 nm, 30-40 nm, 40-50 nm, 50-60 nm, 50-75 nm, 60-70 nm, 70-80 nm, 75-100 nm, 80-90 nm, or 90-100 nm, and/or values including about 1 nm, 5 nm, 10 nm, 20 nm, 30 nm, 40 nm, 50 nm, 60 nm, 70 nm, 80 nm, 90 nm, or 100 nm), in a range of about 100 to about 1,000 nm, inclusive of all values and ranges therebetween (e.g., ranges including about 100-110 nm, 100-125 nm, 100-200 nm, 200-300 nm, 250-500 nm, 300-400 nm, 400-500 nm, 500-600 nm, 500-750 nm, 600-700 nm, 700-800 nm, 750-1,000 nm, 800-900 nm, or 900-1,000 nm, and/or values including about 100 nm, 200 nm, 300 nm, 400 nm, 500 nm, 600 nm, 700 nm, 800 nm, 900 nm, or 1,000 nm), in a range of about 1 μm to about 10 μm, inclusive of all values and ranges therebetween (e.g., ranges including about 1-2 μm, 1-5 nm, 2-3 μm, 3-4 μm, 4-5 μm, 5-10 μm, 5-6 μm, 6-7 μm, 7-8 μm, 8-9 μm, or 9-10 μm, and/or values including about 1 μm, 2 μm, 3 μm, 4 μm, 5 μm, 6 μm, 7 μm, 8 μm, 9 μm, or 10 μm), and/or in a range of about 10 μm to about 100 μm (e.g., ranges including about 10-20 μm, 10-25 μm, 10-50 μm, 20-30 μm, 25-50 μm, 30-40 μm, 40-50 μm, 50-60 μm, 50-75 μm, 60-70 μm, 75-100 μm, 70-80 μm, 80-90 μm, or 90-100 μm, and/or values including about 10 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 40 μm, 50 μm, 60 μm, 70 μm, 80 μm, 90 μm, or 100 μm).

In some embodiments, the cathode 150 can be mixed with a solid-state electrolyte. The solid-state electrolyte can include, or be, at least one of Li _{0.375} O _{0.5} P _{0.125}, Li _{0.3} Br _{0.6} Er _{0.1}, Li _{0.166} B _{0.166} O _{0.5} AI _{0.125} Cl _{0.041}, Li _{0.081} O _{0.648} Al _{0.027} P _{0.162} Ti_{0.081}, Li _{0.3} Cl _{0.6} Er _{0.1}, Li _{0.3} Cl _{0.6} Y _{0.1}, Li _{0.3} Cl _{0.6} Sc _{0.1}, Li _{0.265} O _{0.510} Al _{0.010} Zr _{0.085} La _{0.127}, Li _{0.271} O _{0.508} Ga _{0.008} Zr _{0.084} La _{0.127}, Li _{0.276} O _{0.510} Zr _{0.063} Nb _{0.021} La _{0.127}, Li _{0.270} O _{0.515} Zr _{0.070} La _{0.128} W _{0.015}, Li _{0.3} Cl _{0.6} In _{0.1}, Li _{0.291} O _{0.5} Zr _{0.083} La _{0.125}, Li _{0.3} Br _{0.6} In _{0.1}, Li _{0.3} Sc _{0.1} Br _{0.6}, Li _{0.3} Br _{0.6} Y _{0.1}, Li _{0.260} P _{0.173} S _{0.565}, Li _{0.304} P _{0.043} S _{0.521} Ge _{0.130}, Li _{0.310} P _{0.152} S _{0.537}, Li _{0.308} P _{0.153} S _{0.536} I _{0.001}, Li _{0.333} P _{0.142} S _{0.523}, Li _{0.333} P _{0.142} S _{0.523}, Li _{0.333} P _{0.142} S _{0.523}, Li _{0.325} B _{0.181} S _{0.377} I _{0.115}, Li _{0.337} P _{0.139} S _{0.522} Mo _{0.000}, Li _{0.333} P _{0.138} S _{0.509} Mn _{0.004} I _{0.014}, Li _{0.375} P _{0.125} S _{0.5}, H _{0.004} Li _{0.373} B _{0.001} P _{0.124} S _{0.496}, Li _{0.390} P _{0.121} S _{0.487}, Li _{0.385} Si _{0.070} P _{0.052} S _{0.473} Cl _{0.012} Sb _{0.005}, Li _{0.390} P _{0.097} S _{0.487} Sn _{0.024}, Li _{0.385} Si _{0.070} P _{0.058} S _{0.473} Cl _{0.012}, Li _{0.393} P _{0.090} S _{0.484} Ge _{0.030}, Li _{0.4} Si _{0.04} P _{0.08} S _{0.48}, Li _{0.4} Si _{0.04} P _{0.08} S _{0.48}, Li _{0.4} P _{0.08} S _{0.48} Ge _{0.04}, Li _{0.388} P _{0.111} S _{0.444} I _{0.055}, Li _{0.400} B _{0.000} O _{0.000} Al _{3.503} Si _{0.133} S _{0.465}, Li _{0.4} P _{0.08} S _{0.48} Sn _{0.04}, Li _{0.4} P _{0.08} S _{0.48} Sn _{0.04}, Li _{0.423} Al _{0.038} P _{0.076} S _{0.461}, Li _{0.433} S _{0.452} As _{0.018} Sn _{0.094}, Li _{0.444} S _{0.444} Sn _{0.111}, Li _{0.44} P _{0.08} S _{0.36} Cl _{0.108} I _{0.012}, Li _{0.428} P _{0.142} S _{0.428}, Li _{0.44} P _{0.08} S _{0.36} Cl _{0.12}, Li _{0.44} F _{0.032} P _{0.08} S _{0.36} Cl _{0.088}, Li _{0.44} P _{0.08} S _{0.36} Cl _{0.108} Br _{0.012}, Li _{0.461} O _{0.076} P _{0.076} S _{0.307} Cl _{0.076}, Li _{0.416} Si _{0.106} S _{0.363} I _{0.113}, Li _{0.6} O _{0.2} Cl _{0.2}, Li _{0.461} P _{0.076} S _{0.384} I _{0.076}, Li _{0.461} P _{0.076} S _{0.384} Cl _{0.076}, Li _{0.461} P _{0.076} S _{0.384} Br _{0.076}, Li _{0.481} P _{0.074} S _{0.407} Cl _{0.037}, Li _{0.475} Si _{0.026} P _{0.048} S _{0.374} Br _{0.074}, Li _{0.6} O _{0.2} Br _{0.2}, Li _{0.485} P _{0.029} S _{0.367} Ge _{0.044} I _{0.073}, Li _{0.5} P _{0.071} S _{0.428}, Li _{0.3+x} Cl _{0.6−y} Er _{0.1−z}, Li _{0.3+x} Cl _{0.6−y} Y _{0.1−z}, Li _{0.081+x} O _{0.648−y} Al _{0.027+z} P _{0.162−w} Ti _{0.081−1}, Li _{0.3+x} Cl _{0.6−y} Sc _{0.1−z}, Li _{0.3+x} Br _{0.6−y} Er _{0.1−z}, Li _{0.265+x} O _{0.510−y} Al _{0.010−z} Zr _{0.085+w} La _{0.127+1}, Li _{0.271+x} O _{0.508−y} Ga _{0.008−z} Zr _{0.084+w} La _{0.127+1}, Li _{0.276+x} O _{0.510−y} Zr _{0.063+z} Nb _{0.021−w} La _{0.127+1}, Li _{0.166+x} B _{0.166−y} O _{0.5−z} Al _{0.125+w} Cl _{0.041+1}, Li _{0.291+x} O _{0.5−y} Zr _{0.083−z} La _{0.125−w}, Li _{0.270+x} O _{0.515−y} Zr _{0.070−z} La _{0.128+w} W _{0.015−1}, Li _{0.400−x} B _{0.000−y} O _{0.000−z} Al _{3.503+w} Si _{0.133−1} S _{0.465−m}, Li _{0.3+x} Cl _{0.6−y} In _{0.1−z}, Li _{0.3+x} Sc _{0.1−y} Br _{0.6−z}, Li _{0.3+x} Br _{0.6−y} Y _{0.1−z}, Li _{0.3+x} Br _{0.6−y} In _{0.1−z}, Li _{0.325−x} B _{0.181+y} S _{0.377+z} I _{0.115−w}, Li _{0.260+x} P _{0.173+y} S _{0.565−z}, Li _{0.375+x} P _{0.125+y} S _{0.5−z}, Li _{0.304+x} P _{0.043+y} S _{0.521−z} Ge _{0.130+w}, Li _{0.310+x} P _{0.152+y} S _{0.537−z}, Li _{0.333+x} P _{0.142+y} S _{0.523−z}, Li _{0.333+x} P _{0.142+y} S _{0.523−z}, Li _{0.333+x} P _{0.142+y} S _{0.523−z}, Li _{0.375+x} O _{0.5−y} P _{0.125−z}, Li _{0.308+x} P _{0.153+y} S _{0.536−z} I _{0.001−w}, Li _{0.333+x} P _{0.138+y} S _{0.509−z} Mn _{0.004−w} I _{0.014+1}, Li _{0.337+x} P _{0.139+y} S _{0.522−z} Mo _{0.000+w}, Li _{0.6−x} O _{0.2−y} Cl _{0.2+z}, Li _{0.388+x} P _{0.111+y} S _{0.444−z} I _{0.055+w}, H _{0.004+x} Li _{0.373+y} B _{0.001−z} P _{0.124+w} S _{0.496−1}, Li _{0.461+x} O _{0.076+y} P _{0.076−z} S _{0.307−w} Cl _{0.076−1}, Li _{0.390+x} P _{0.097+y} S _{0.487−z} Sn _{0.024+w}, Li _{0.393+x} P _{0.090+y} S _{0.484−z} Ge _{0.030+w}, Li _{0.6+x} O _{0.2+y} Br _{0.2−z}, Li _{0.390+x} P _{0.121+y} S _{0.487−z}, Li _{0.4+x} P _{0.08+y} S _{0.48−z} Ge _{0.04+w}, Li _{0.385+x} Si _{0.070+y} P _{0.052−z} S _{0.473−w} Cl _{0.012−1} Sb _{0.005−m}, Li _{0.385+x} Si _{0.070+y} P _{0.058−z} S _{0.473−w} Cl _{0.012−1}, Li _{0.416+x} Si _{0.106+y} S _{0.363−z} I _{0.113−w}, Li _{0.461+x} P _{0.076−y} S _{0.384−z} Br _{0.076+w}, Li _{0.4+x} Si _{0.04+y} P _{0.08−z} S _{0.48−w}, Li _{0.4+x} Si _{0.04+y} P _{0.08−z} S _{0.48−w}, Li _{0.4+x} P _{0.08−y} S _{0.48−z} Sn _{0.04+w}, Li _{0.4+x} P _{0.08−y} S _{0.48−z} Sn _{0.04+w}, Li _{0.428+x} P _{0.142−y} S _{0.428−z}, Li _{0.423+x} Al _{0.038+y} P _{0.076−z} S _{0.461−w}, Li _{0.444+x} S _{0.444−y} Sn _{0.111−z}, Li _{0.433+x} S _{0.452−y} As _{0.018−z} Sn _{0.094−w}, Li _{0.485+x} P _{0.029−y} S _{0.367−z} Ge _{0.044+w} I _{0.073−1}, Li _{0.44+x} P _{0.08−y} S _{0.36−z} Cl _{0.108−w} I _{0.012+1}, Li _{0.44+x} P _{0.08−y} S _{0.36−z} Cl _{0.108−w} Br _{0.012+1}, Li _{0.44+x} P _{0.08−y} S _{0.36−z} Cl _{0.12−w}, Li _{0.44+x} F _{0.032−y} P _{0.08−z} S _{0.36−w} Cl _{0.088−1}, Li _{0.475+x} Si _{0.026+y} P _{0.048−z} S _{0.374−w} Br _{0.074−1}, Li _{0.461+x} P _{0.076−y} S _{0.384−z} Cl _{0.076−w}, Li _{0.461+x} P _{0.076−y} S _{0.384−z} I _{0.076−w}, Li _{0.481+x} P _{0.074−y} S _{0.407−z} Cl _{0.037−w}, or Li _{0.5+x} P _{0.071−y} S _{0.428−z}, where ‘_{#}’ and ‘_{#±x, y, z, w, l, or m}’ represent non-stoichiometric weightings of an element immediately to the left of ‘_{#}’ or ‘_{#±x, y, z, w, l, or m}’ in a chemical formula of the material, wherein # can be in the range of #±n, wherein 0≤n≤0.5, wherein 0≤x, y, z, w, l, and m≤#, and wherein # can be ±n, 0≤n≤0.5.

The separator 160 is disposed between the anode 130 and the cathode 150. In some embodiments, the separator 160 may include a solid-state electrolyte. In some embodiments, the separator 160 may include a first solid-state electrolyte (not shown) and a second solid-state electrolyte (not shown). In some embodiments, the first solid-state electrolyte may be disposed on the anode 130. In some embodiments, the second solid-state electrolyte may be disposed on the first solid-state electrolyte. In some embodiments, the first solid-state electrolyte may be stable with respect to an alkali metal, for example, the alkali metal included in the anode 130. In some embodiments, the second solid-state electrolyte may be reactive with respect to the alkali metal. Thus, the first solid-state electrolyte may allow any dendrites growing from the anode 130 towards the cathode 150 to pass therethrough, and the second solid-state electrolyte may react with and/or consume the dendrites to inhibit or prevent the dendrites from passing through the second solid-state electrolyte and contacting the cathode 150. In this manner, the bilayer solid-state electrolyte may prevent short circuiting of the electrochemical cell.

In some embodiments, the first solid-state electrolyte may include, or be, at least one of Li₆PS₅Cl, Li_{6±y}PS_{5±y}Cl_{1±y}, Li_{5.5}PS_{4.5}Cl_{1.5}, Li_{5.5±y}PS_{4.5±y}Cl_{1.5±y}, Li_{6±y}PS_{5±y}Br_{1±y}, Li_{6±y}PS_{5±y}I_{1±y}, Li_{6±y}PS_{5±y}F_{1±y}, Li₆PS₅Cl₁₋ₓFₓ (0≤x≤C), Li_{6±y}PS_{5±y}(Cl₁₋ₓFₓ)_{1±y} (0≤x≤C), Li_{6±y}PS_{5±y}(Cl₁₋ₓBrₓ)_{1±y} (0≤x≤C), Li_{6±y}PS_{5±y}(Cl₁₋ₓIₓ)_{1±y} (0≤x≤C), Li_{6±y}PS_{5±y}(BrᵤIᵥF_{w}Cl_{1-u-v-w})_{1±y} (0≤u, v, w≤C), LiₓP_{y}S_{z}(BrᵤIᵥF_{w}Cl_{1-u-v-w})ₚ (0≤u, v, w≤C, 0≤x, y, z, p≤7), Li₇P₂S₈I, Li₃PS₄, Li_{3±x}P_{1±y}S_{4±z}, 54Li₃PS₄—46LiI, xLi₃PS4—(1−x)LiI, Li_{9.6}P₃S₁₂, Li₃ClO, Li₃BrO, Li₃BrₓCl₁₋ₓO, Li₇La₃Zr₂O₁₂, Li_{6.75}La₃Zr_{1.75}Ta_{0.5}O₁₂, Li_{6.75±x}La_{3±y}Zr_{1.75±z}Ta_{0.5±u}O_{12±v}, Li_{6.25}Al_{0.25}La₃Zr₂O₁₂, Li_{6.25±x}Al_{0.25±y}La_{3±z}Zr_{2±u}O_{12±v}, Li_{6.3}La₃Zr_{1.65}W_{0.35}O₁₂, Li_{6.3±x}La_{3±y}Zr_{1.65±z}W_{0.35±u}O_{12±v}, Li_{6.5}La₃Zr_{1.5}Nb_{0.5}O₁₂, Li_{6.5±x}La_{3±y}Zr_{1.5±z}Nb_{0.5±u}O_{12±v}, LiₓPO_{y}N_{z} (0<x=2y+3z−5≤3), Li_{6.4}Ga_{0.2}La₃Zr₂O₁₂, Li_{6.4±x}Ga_{0.2±y}La_{3±u}Zr_{2±v}O_{12±w}, Li₃PO₄, Li₃YCl₆, Li₃YBr₆, Li₃InCl₆, Li₃InBr₆, Li₃ErCl₆, Li₃ErBr₆, Li₃ScCl₆, Li₃ScBr₆, and Li₃(YₓIn_{y}Sc_{1-x-y})(FᵤBrᵥCl₁₋ᵤ₋ᵥ)₆, wherein 0≤a, b, d, p, q, w, x, y, z, u, v, and w≤1 unless otherwise specified, wherein C is the critical doping content, above which the electrolyte become less stable, and wherein C can be varied for u, v, and w; 0≤C≤1.

In some embodiments, the second solid-state electrolyte may include, or be, at least one of Li₁₀GeP₂S₁₂, Li_{10±x}Ge_{1±y}P_{2±p}S_{12±q}, Li_{10±x}Ge_{1±y}(PpSb₂₋ₚ)S_{12±q}, Li₁₀SiP₂S₁₂, Li_{10±x}Si_{1±y}P_{2±p}S_{12±q}, Li₁₀SnP₂S₁₂, Li_{10±x}Sn_{1±y}P_{2±p}S_{12±q}, Li_{10±x}Sn_{1±y}(PₚSb₂₋ₚ)S_{12±q}, Li_{6±y}P₍₁₋ₓ₎SbₓS_{5±y}(BrᵤlᵥFwCl_{1-u-v-w})_{1±y} (x≥C, 0≤u, v, w≤1), Li_{6±y}P₍₁₋ₓ₎SbₓS_{5±y}(BrᵤlᵥF_{w}Cl_{1-u-v-w})_{1±y} (u, v, w≥C, 0≤x≤1), Li_{3±x}P_{1±y}S_{4±z}, L_{i9.54}Si_{1.74}P_{1.44}S_{11.7}Cl_{0.3}, Li_{10±x}Si_{1±y}P_{2±p}S_{12±q}Clw, Li_{9.54}Si_{1.74}(PₓSb₁₋ₓ)_{1.44}S_{11.7}Cl_{0.3}, Li_{10±x}Si_{1±y}(PₓSb₁₋ₓ)_{2±p}S_{12±q}Cl_{w}, Li_{10±x}Si_{1±y}(PₓSb₁₋ₓ)_{2±p}S_{12±q}(FᵤBrᵥI_{w}Cl_{1-u-v-w})_{z}, Li_{10±x}(SiₐSn_{b}Ge_{1-a-b})_{1±y}(PₓSb₁₋ₓ)_{2±p}(S_{d}Se_{1-d})_{12±q}(FᵤBrᵥl_{w}Cl_{1-u-v-w})_{z}, Li_{3.2}P_{0.8}Sn_{0.2}S₄, Li_{3.2±x}P_{0.8±y}Sn_{0.2±z}S_{4±u}, Li₇P₃S₁₁, 75Li₂S—25P₂S₅, (x)Li₂S—(1−x)P₂S₅, Li₇Ge₃PS₁₂, Li_{1.5}AI_{0.5}Ti_{1.5}(PO₄)₃, Li₇₊ₓGe_{3+y}P_{1+z}S₁₂₊ᵤ, Li₆PS₅Cl₁₋ₓFₓ (x≥C), Li_{6±y}PS_{5±y}(Cl₁₋ₓFₓ)_{1±y} (x≥C), Li_{6±y}PS_{5±y}(Cl₁₋ₓBrₓ)_{1±y} (x≥C), Li_{6±y}PS_{5±y} (Cl₁₋ₓlₓ)_{1±y} (x≥C), Li_{6±y}PS_{5±y}(BrᵤlᵥF_{w}Cl_{1-u-v-w})_{1±y} (u, v, w≥C), LiₓP_{y}S_{z}(BrᵤlᵥF_{w}Cl_{1-u-v-w})ₚ (u, v, w≥C, 0≤x, y, z, p≤7), nLiX-xACl₃—(1−x)GaF₃ (n=2, 3, 4, X=CI, Br, A=La, In) , nLiCl—LiOH—GaF₃(n=2, 3, 4) , or nLiX-GaF₃ (X=Cl, Br, n=2, 3, 4), wherein 0≤a, b, d, p, q, w, x, y, z, u, v, and w≤1 unless otherwise specified, wherein C is the critical doping content, above which the electrolyte become less stable, and wherein C can be varied for u, v, and w; 0≤C≤1.

In some embodiments, the first solid-state electrolyte may include, or be, at least one of Na₃PS₄, Na_{3±x}P_{1±y}S_{4±z}, Na_{2.9375}PS_{3.9375}Cl_{0.0625}, Na_{3±x}P_{1±y}S_{4±z}Cl_{w}, Na_{3±x}(P₁₋ᵤ₋ᵥSbᵤWᵥ)_{1±y} (S_{1-w}Se_{w})_{4±z} (0≤u, v, w<C), Na₃YCl₆, Na₃YBr₆, Na₃InCl₆, Na₃InBr₆, Na₃ErCl₆, Na₃ErBr₆, Na₃ScCl₆, Na₃ScBr₆, Na₃(YₓIn_{y}SC_{1-x-y})(FᵤBrᵥCl₁₋ᵤ₋ᵥ)₆, or Na₃(YₓIn_{y}Sc_{z}X_{1-x-y-Z})(FᵤBrᵥCh₁₋ᵤ₋ᵥ)₆ (X=transition metal), wherein 0≤p, q, w, x, y, z, u, v, and w≤1 unless otherwise specified, wherein C is the critical doping content above which the electrolyte become less stable, and wherein C can be varied for u, v, and w; 0≤C≤1.

In some embodiments, the second solid-state electrolyte may include, or be, at least one of Na₁₀GeP₂S₁₂, Na_{10±x}Ge_{1±y}P_{2±p}S_{12±q}, Na_{10±x}Ge_{1±y}(PₚSb₂₋ₚ)S_{12±q}, Na_{10±x}(GeᵤSi_{z}Sn_{1-u-z})_{1±y}(PᵥAsᵢSb₁₋ᵥ₋ᵢ)_{2±p}(S_{w}Se_{l-w})_{12±q}, Na_{2.88}Sb_{0.88}W_{0.12}S₄, Na_{2.88±x}Sb_{0.88±y}W_{0.12±z}S_{4±w}, or Na_{3±x}(P₁₋ᵤ₋ᵥSbᵤWᵥ)_{1±y} (S_{1-w}Se_{w})_{4±z} (u, v, w≥C), wherein 0≤p, q, w, x, y, z, u, v, and w≤1 unless otherwise specified, wherein C is the critical doping content above which the electrolyte become less stable, and wherein C can be varied for u, v, and w; 0≤C≤1.

In some embodiments, the first solid-state electrolyte may include, or be, at least one of Li _{0.3} Cl _{0.6} Er _{0.1}, Li _{0.3} Cl _{0.6} Y _{0.1}, Li _{0.3} Cl _{0.6} Sc _{0.1}, Li _{0.291} O _{0.5} Zr _{0.083} La _{0.125}, Li _{0.271} O _{0.508} Ga _{0.008} Zr _{0.084} La _{0.127}, Li _{0.265} O _{0.510} Al _{0.010} Zr _{0.085} La _{0.127}, Li _{0.276} O _{0.510} Zr _{0.063} Nb _{0.021} La _{0.127}, Li _{0.270} O _{0.515} Zr _{0.070} La _{0.128} W _{0.015}, Li _{0.400−x} B _{0.000−y} O _{0.000−z} AI _{3.503+w} Si _{0.133−I} S _{0.465−m}, Li _{0.3+x} CI _{0.6−y} Sc _{0.1−z}, Li _{0.3+x} CI _{0.6−y} In _{0.1−z}, Li _{0.3+x} CI _{0.6−y} Er _{0.1−z}, Li _{0.3+x} CI _{0.6−y} Y _{0.1−z}, Li _{0.444+x} S _{0.444−y} Sn _{0.111−z}, Li _{0.44+x} P _{0.08−y} S _{0.36−z} CI _{0.12−w}, Li _{0.270+x} O _{0.515−y} Zr _{0.070−z} La _{0.128+w} W _{0.015−1}, Li _{0.265+x} O _{0.510−y} Al _{0.010−z} Zr _{0.085+w} La _{0.127+1}, Li _{0.291+x} O _{0.5−y} Zr _{0.083−z} La _{0.125−w}, Li _{0.276+x} O _{0.510−y} Zr _{0.063+z} Nb _{0.021−w} La _{0.127+1}, or Li _{0.166+x} B _{0.166−y} O _{0.5−z} Al _{0.125+w} Cl _{0.041+1}, wherein ‘_{#}’ and ‘_{#±x, y, z, w, l, or m}’ represent non-stoichiometric weightings of an element immediately to the left of ‘_{#}’ or ‘_{#±x, y, z, w, l, or m}’ in a chemical formula of the material, wherein # can be in the range of #±n, wherein 0≤n≤0.5, wherein 0≤x, y, z, w, l, and m≤#, and wherein # can be ±n, 0≤n≤0.5.

In some embodiments, the second solid-state electrolyte may include, or be, at least one of Li _{0.6} O _{0.2} Cl _{0.2}, Li _{0.6} O _{0.2} Br _{0.2}, Li _{0.3} Br_{0.6} Er _{0.1}, Li _{0.3} Br _{0.6} Y _{0.1}, Li _{0.3} Sc _{0.1} Br _{0.6}, Li _{0.3} Br _{0.6} In _{0.1}, Li _{0.375} O _{0.5} P _{0.125}, Li _{0.3} CI _{0.6} In _{0.1}, Li _{0.166} B _{0.166} O _{0.5} Al _{0.125} Cl _{0.041}, Li _{0.444} S _{0.444} Sn _{0.111}, Li _{0.416} Si _{0.106} S _{0.363} I _{0.113}, Li _{0.428} P _{0.142} S _{0.428}, Li _{0.485} P _{0.029} S _{0.367} Ge _{0.044} I _{0.073}, Li _{0.433} S _{0.452} As _{0.018} Sn _{0.094}, Li _{0.325} B _{0.181} S _{0.377} I _{0.115}, Li _{0.475} Si _{0.026} P _{0.048} S _{0.374} Br _{0.074}, Li _{0.461} O _{0.076} P _{0.076} S _{0.307} CI _{0.076}, Li _{0.400} B _{0.000} O _{0.000} AI _{3.503} Si _{0.133} S _{0.465}, Li _{0.461} P _{0.076} S _{0.384} I _{0.076}, Li _{0.44} P _{0.08} S _{0.36} CI _{0.108} Br _{0.012}, Li _{0.44} P _{0.08} S _{0.36} Cl _{0.108} I _{0.012}, Li _{0.44} P _{0.08} S _{0.36} Cl _{0.12}, Li _{0.388} P _{0.111} S _{0.444} I _{0.055}, Li _{0.6+x} O _{0.2+y} Br _{0.2−z}, Li _{0.6−x} O _{0.2−y} Cl _{0.2+z}, Li _{0.3+x} Br _{0.6−y} In _{0.1−z}, Li _{0.3+x} Br _{0.6−y} Y _{0.1−z}, Li _{0.3+x} Br _{0.6−y} Er _{0.1−z}, Li _{0.416+x} Si _{0.106+y} S _{0.363−z} I _{0.113−w}, Li _{0.3+x} Sc _{0.1−y} Br _{0.6−z}, Li _{0.166+x} B _{0.166−y} O _{0.5−z} AI _{0.125+w} Cl _{0.041+1}, Li _{0.375+x} O _{0.5−y} P _{0.125−z}, Li _{0.485+x} P _{0.029−y} S _{0.367−z} Ge _{0.044+w} I _{0.073−1}, Li _{0.5+x} P _{0.071−y} S _{0.428−z}, Li _{0.461+x} P _{0.076−y} S _{0.384−z} I _{0.076−w}, Li _{0.433+x} S _{0.452−y} As _{0.018−z} Sn _{0.094−w}, Li _{0.481+x} P _{0.074−y} S _{0.407−z} Cl _{0.037−w}, Li _{0.461+x} O _{0.076+y} P _{0.076−z} S _{0.307−w} Cl _{0.076−1}, Li _{0.475+x} Si _{0.026+y} P _{0.048−z} S _{0.374−w} Br _{0.074−1}, Li _{0.461+x} P _{0.076−y} S _{0.384−z} Br _{0.076+w}, Li _{0.461+x} P _{0.076−y} S _{0.384−z} Cl _{0.076−w}, Li _{0.44+x} P _{0.08−y} S _{0.36−z} CI _{0.108−w} Br _{0.012+1}, Li _{0.44+x} P _{0.08−y} S _{0.36−z} CI _{0.108−w} I _{0.012+1}, Li _{0.428+x} P _{0.142−y} S _{0.428−z}, Li _{0.423+x} AI _{0.038+y} P _{0.076−z} S _{0.461−w}, Li _{0.4+x} Si _{0.04+y} P _{0.08−z} S _{0.48−w}, Li _{0.4+x} Si _{0.04+y} P _{0.08−z} S _{0.48−w}, Li _{0.44+x} F _{0.032−y} P _{0.08−z} S _{0.36−w} Cl _{0.088−1}, Li _{0.4+x} P _{0.08−y} S _{0.48−z} Sn _{0.04+w}, Li _{0.4+x} P _{0.08−y} S _{0.48−z} Sn _{0.04+w}, Li _{0.385+x} Si _{0.070+y} P _{0.058−z} S _{0.473−w} Cl _{0.012−1}, Li _{0.388+x} P _{0.111+y} S _{0.444−z} I _{0.055+w}, Li _{0.385+x} Si _{0.070+y} P _{0.052−z} S _{0.473−w} Cl _{0.012−1} Sb _{0.005−m}, Li _{0.310+x} P _{0.152+y} S _{0.537−z}, Li _{0.375+x} P _{0.125+y} S _{0.5−z}, Li _{0.308+x} P _{0.153+y} S _{0.536−z} I _{0.001−w}, Li _{0.333+x} P _{0.142+y} S _{0.523−z}, Li _{0.333+x} P _{0.142+y} S _{0.523−z}, Li _{0.333+x} P _{0.142+y} S _{0.523−z}, Li _{0.333+x} P _{0.138+y} S _{0.509−z} Mn _{0.004−w} I _{0.014+1}, Li _{0.260+x} P _{0.173+y} S _{0.565−z}, Li _{0.390+x} P _{0.121+y} S _{0.487−z}, Li _{0.337+x} P _{0.139+y} S _{0.522−z} Mo _{0.000+w}, Li _{0.390+x} P _{0.097+y} S _{0.487−z} Sn _{0.024+w}, Li _{0.004+x} Li _{0.373+y} B _{0.001−z} P _{0.124+w} S _{0.496−1}, Li _{0.393+x} P _{0.090+y} S _{0.484−z} Ge _{0.030+w}, Li _{0.4+x} P _{0.08+y} S _{0.48−z} Ge _{0.04+w}, Li _{0.304+x} P _{0.043+y} S _{0.521−z} Ge _{0.130+w}, Li _{0.325−x} B _{0.181+y} S _{0.377+z} I _{0.115−w}, or Li _{0.081+x} O _{0.648−y} Al _{0.027+z} P _{0.162−w} Ti _{0.081−1}, wherein ‘_{#}’ and ‘_{#+x, y, z, w, l, or m}’ represent non-stoichiometric weightings of an element immediately to the left of ‘_{#}’ or ‘_{#+x, y, z, w, l, or m}’ in a chemical formula of the material, wherein # can be in the range of #±n, wherein 0≤n≤0.5, wherein 0≤x, y, z, w, l, and m≤#, and wherein # can be ±n, 0≤n≤0.5.

In some embodiments, the first solid-state electrolyte may include, or be, at least one of Na _{0.300} Cl _{0.600} Y _{0.100}, O _{0.2} Na _{0.6} Br _{0.2}, Na _{0.291} Cl _{0.607} Y _{0.088} Zr _{0.012}, Na _{0.282} Cl _{0.615} Y _{0.076} Zr _{0.025}, H _{0.600} Na _{0.300} Al _{0.100}, H _{0.46} B _{0.46} Na _{0.08}, O _{0.6} Al _{0.4}, H _{0.458} B _{0.458} Na _{0.083}, O _{0.588} Na _{0.166} Si _{0.098} P _{0.049} Sc _{0.019} Zr _{0.078}, H _{0.666} Na _{0.166} Al _{0.166}, O _{0.614} Na _{0.067} Zr _{0.204} La _{0.112}, H _{0.454} B _{0.454} Na _{0.090}, O _{0.6} Na _{0.15} Si _{0.1} P _{0.05} Zr _{0.1}, Na _{0.272} Cl _{0.623} Y _{0.064} Zr _{0.038}, O _{0.588} Na _{0.166} Si _{0.098} P _{0.049} Zn _{0.009} Zr _{0.088}, O _{0.601} Na _{0.066} Sr _{0.066} Zr _{0.200} La _{0.066}, Na _{0.263} Cl _{0.631} Y _{0.052} Zr _{0.052}, Na _{0.243+x} Cl _{0.648−y} Y _{0.027+z} Zr _{0.081+w}, O _{0.2+x} Na _{0.6+y} Br _{0.2−z}, Na _{0.300−x} Cl _{0.600−y} Y _{0.100+z}, Na _{0.232+x} Cl _{0.657−y} Y _{0.013+z} Zr _{0.095+w}, Na _{0.263+x} Cl _{0.631−y} Y _{0.052+z} Zr _{0.052+w}, Na _{0.253+x} Cl _{0.640−y} Y _{0.040+z} Zr _{0.066−w}, Na _{0.291−x} Cl _{0.607+y} Y _{0.088+z} Zr _{0.012+w}, Na _{0.282−x} Cl _{0.615+y} Y _{0.076+z} Zr _{0.025−w}, Na _{0.272−x} Cl _{0.623+y} Y _{0.064+z} Zr _{0.038−w}, H _{0.600+x} Na _{0.300−y} Al _{0.100+z}, O _{0.588−x} Na _{0.166+y} Si _{0.098+z} P _{0.049−w} Sc _{0.019+1} Zr _{0.078+m}, Na _{0.370+x} P _{0.125+y} S _{0.496−z} Cl _{0.007−w}, O _{0.614−x} Na _{0.067−y} Zr _{0.204−z} La _{0.112+w}, Na _{0.365+x} S _{0.507−y} Sb _{0.111−z} W _{0.015+w}, O _{0.601−x} Na _{0.066+y} Sr _{0.066+z} Zr _{0.200+w} La _{0.066+1}, O _{0.588−x} Na _{0.166+y} Si _{0.098+z} P _{0.049−w} Zn _{0.009−1} Zr _{0.088+m}, Na _{0.379+x} Si _{0.007−y} P _{0.116+z} S _{0.496−w}, O _{0.631−x} Na _{0.157+y} P _{0.157−z} La _{0.052+w}, Na _{0.347+x} P _{0.127+y} S _{0.508−z} Ca _{0.017−w}, Na _{0.423+x} P _{0.038+y} S _{0.461−z} Sn _{0.076−w}, Na _{0.375+x} P _{0.125+y} S _{0.5−z}, O _{0.6−x} Na _{0.15+y} Si _{0.1+z} P _{0.05−w} Zr _{0.1−1}, Na _{0.423+x} S _{0.461−y} Sn _{0.076+z} Sb _{0.038+w}, or Na _{0.375+x} S _{0.5−y} Sb _{0.125+z}, wherein ‘_{#}’ and ‘_{#±x, y, z, w, l, or m}’ represent non-stoichiometric weightings of an element immediately to the left of ‘_{#}’ or ‘_{##x, y, z, w, l, or m}’ in a chemical formula of the material, wherein # can be in the range of #±n, wherein 0≤n≤0.5, wherein 0≤x, y, z, w, l, and m≤#, and wherein # can be ±n, 0≤n≤0.5.

In some embodiments, the second solid-state electrolyte may include, or be, at least one of H _{0.444} B _{0.111} O _{0.111} Na _{0.333}, O _{0.142} Na _{0.571} I _{0.285}, Na _{0.423} P _{0.038} S _{0.461} Sn _{0.076}, Na _{0.379} Si _{0.007} P _{0.116} S _{0.496}, Na _{0.375} P _{0.125} S _{0.5}, Na _{0.370} P _{0.125} S _{0.496} Cl _{0.007}, Na _{0.347} P _{0.127} S _{0.508} Ca _{0.017}, O _{0.2} Na _{0.6} Br _{0.12} I _{0.08}, Na _{0.375} P _{0.125} Se _{0.5}, O _{0.202} Na _{0.585} Br _{0.121} Sr _{0.010} I _{0.080}, Na _{0.365} S _{0.507} Sb _{0.111} W _{0.015}, Na _{0.423} P _{0.038} Se _{0.461} Sn _{0.076}, Na _{0.423} S _{0.461} Sn _{0.076} Sb _{0.038}, Na _{0.375} Se _{0.5} Sb _{0.125}, Na _{0.375} S _{0.5} Sb _{0.125}, Na _{0.378} S _{0.486} Sb _{0.121}l _{0.013}, Na _{0.253} Cl _{0.640} Y _{0.040} Zr _{0.066}, Na _{0.243} Cl _{0.648} Y _{0.027} Zr _{0.081}, Na _{0.232} Cl _{0.657} Y _{0.013} Zr _{0.095}, Na _{0.222} Cl _{0.666} Zr _{0.111}, O _{0.631} Na _{0.157} P _{0.157} La _{0.052}, H _{0.454−x} B _{0.454+y} Na _{0.090+z}, H _{0.444−x} B _{0.111+y} O _{0.111+z} Na _{0.333−w}, H _{0.458−x} B _{0.458+y} Na _{0.083+z}, H _{0.46−x} B _{0.46+y} Na _{0.08+z}, H _{0.666+x} Na _{0.166−y} Al _{0.166−z}, O _{0.142+x} Na _{0.571+y} l _{0.285−z}, Na _{0.375+x} P _{0.125+y} Se _{0.5−z}, Na _{0.378+x} S _{0.486−y} Sb _{0.121−z} l _{0.013−w}, O _{0.2−x} Na _{0.6+y} Br _{0.12−z} I _{0.08+w}, O _{0.202+x} Na _{0.585+y} Br _{0.121−z} Sr _{0.010−w} I _{0.080+1}, Na _{0.375+x} Se _{0.5−y} Sb _{0.125+z}, Na _{0.423+x} P _{0.038+y} Se _{0.461−z} Sn _{0.076+w}, O _{0.6−x} Al _{0.4+y}, or Na _{0.222+x} Cl _{0.666−y} Zr _{0.111+z}, wherein ‘_{#}’ and ‘_{##x, y, z, w, l, or m}’ represent non-stoichiometric weightings of an element immediately to the left of ‘_{#}’ or ‘_{#+x, y, z, w, l, or m}’ in a chemical formula of the material, wherein # can be in the range of #±n, wherein 0≤n≤0.5, wherein 0≤x, y, z, w, l, and m≤#, and wherein # can be ±n, 0≤n≤0.5.

In some embodiments, at least one of the first solid-state electrolyte and the second solid-state electrolyte may have a core-shell particle structure. In some embodiments, the core and the shell of first solid-state electrolyte and/or the second solid-state electrolyte may include the same material, for example, any of the materials described herein. In some embodiments, the core may include a first material, and the shell may include a second material that is different from the first material. The first material and/or the second material can include any of the solid-state electrolyte materials described herein.

In some embodiments, the electrochemical cell 100 can include a silicon (Si) material. For example, in some embodiments, the silicon (Si) material may be included (e.g., incorporated, disposed, etc.) in at least one of the electrodes, or the active material of at least one of the electrodes. In some embodiments, the silicon (Si) material can be included in the anode 130 or the cathode 150. In some embodiments, the silicon (Si) material may be included in at least one of the anode active material of the anode 130 or the cathode active material of the cathode 150. In some embodiments, the silicon (Si) material may be included only in the anode 130, for example, in the anode active material of the anode 130.

In some embodiments, the silicon (Si) material may include, or be, at least one of Si particles, Si nanowires, Si nanospheres, Si nanoparticles, Si thin films, porous silicon, silicon monoxide (SiO), silicon oxycarbide, silicon carbide (Si/C) composites, or other silicon composite materials suitable for incorporation in an electrochemical cell.

Without being bound by theory, incorporating the silicon (Si) material into the electrochemical cell 100, for example, into at least one of the electrodes (e.g., anode 130, cathode 150), may improve a charge capacity of the electrode including the silicon (Si) material and/or an overall charge capacity of the electrochemical cell 100.

The binder 110 can be incorporated (e.g., included, disposed, mixed, etc.) in at least one of the components of the electrochemical cell 100. In some embodiments, the binder 110 can be incorporated in at least one of the anode 130, the cathode 150, or the separator 160. In some embodiments, the binder 110 can be incorporated in the solid-state electrolyte (e.g., the first solid-state electrolyte or the second solid-state electrolyte) included in at least one of the anode 130, the cathode 150, or the separator 160.

In some embodiments, the binder 110 can be incorporated into the anode 130, for example, during a mixing or formation of the anode 130. Without being bound by theory, incorporating the binder 110 into the anode 130 may enable improved casting of the anode 130, especially if the anode 130 includes the silicon (Si) material. In some embodiments, the binder 110 includes polar functionalities to achieve improved interaction with a polar surface of the silicon (Si) material over conventional binders. In some embodiments, the binder 110 may improve a stability of an electrode slurry or solid-state electrolyte slurry, reduce a viscosity of the electrode slurry or solid-state electrolyte slurry, and/or improve overall performance of the electrochemical cell 100.

In some embodiments, the binder 110 can improve a dispersion of the conductive material (e.g., anode conductive material, cathode conductive material, carbon, graphite, graphitic materials, etc.), for example, included in the electrode (e.g., the anode 130 or the cathode 150). Without being bound by theory, the electrochemical cell 100 including the binder 110 may have improved rate capabilities (e.g., charge rate or discharge rate) over electrochemical cells that do not include the binder 110. The improved dispersion of the conductive material in the electrodes may enable conductive percolating networks or pathways to form through the electrodes, enabling improved electronic conductivity and/or improved rate capabilities (e.g., charge rate or discharge rate). In some embodiments, the electrochemical cell 100 including the binder 110 may be configured to run under 5 C charge rate conditions and/or under 0.5 C discharge rate conditions, which is not possible with conventional binders.

Furthermore, without being bound by theory, in some embodiments in which the electrochemical cell 100 includes the binder 110, the conductive material, and the silicon (Si) material in at least one of the electrodes (e.g., anode 130, cathode 150), the binder 110 may improve the dispersion of the conductive material, and the conductive material may protect at least a portion of the silicon (Si) material from pulverization, for example, during mixing. This may, for example, enable the electrochemical cell 100 including the binder 110, the conductive material, and the silicon (Si) material to achieve improved utilization of the silicon (Si) material and/or improved capacity or capacity retention over electrochemical cells not containing these components.

In some embodiments, the electrochemical cell 100, for example, including the binder 110 of the present disclosure, may exhibit higher specific capacity, higher rate capabilities, longer cycle life, and improved safety over electrochemical cells including conventional or traditional binders. The enhanced electrochemical and mechanical properties can contribute to better overall battery performance.

In some embodiments, the separator 160 of the electrochemical cell 100 described herein can include a solid-state electrolyte multilayer for example, include at least two layers, at least three layers, at least four layers, or even more layers of solid-state electrode materials stack on top of each other in any suitable order. In some embodiments, the separator 160, or solid-state electrolyte multilayer, can include a first solid-state electrolyte disposed on the anode 130 and a second solid-state electrolyte disposed on the first solid-state electrolyte. In some embodiments, the electrochemical cell 100, for example including the including the binder 110 (e.g., a solid-state battery) may include a bipolar structure, for example, anode and cathode materials can be disposed on two sides of one current collector and the electrochemical cell 100 can be stacked in series with other electrochemical cells. Examples of electrochemical cells including a solid-state electrolyte multilayer are described in PCT Publication No. WO2022/094412, filed on Nov. 1, 2021, and entitled “Batteries with Solid State Electrolyte Multilayers,” the entire disclosure of which is hereby incorporated by reference.

In some embodiments, the binder 10 as described herein with respect to FIG. 1, the electrochemical cell 100 or any component thereof as described herein with respect to FIG. 2 (e.g., binder 110, first portion 112, second portion 114, functional portion 116, anode current collector 120, anode 130, cathode current collector 140, cathode 150, and/or separator 160) can be incorporated into systems or apparatuses configured to pressurize electrochemical cells to increase cell performance. Examples of systems, apparatus, or methods configured to pressurize electrochemical cells to increase cell performance, and/or further examples of solid-state electrochemical cells and/or their components into which the binder 10 and/or binder 110 may be incorporated into, such as anodes, cathodes, or solid-state separators, which may be substantially similar to the anode, or the same as, anode 130, cathode 150, or separator 160, are described in PCT Publication No. WO2025/059075, filed on Sep. 10, 2024, and entitled “Systems and Methods for Applying Isostatic Pressure on Electrochemical Cells,” the entire disclosure of which is hereby incorporated by reference.

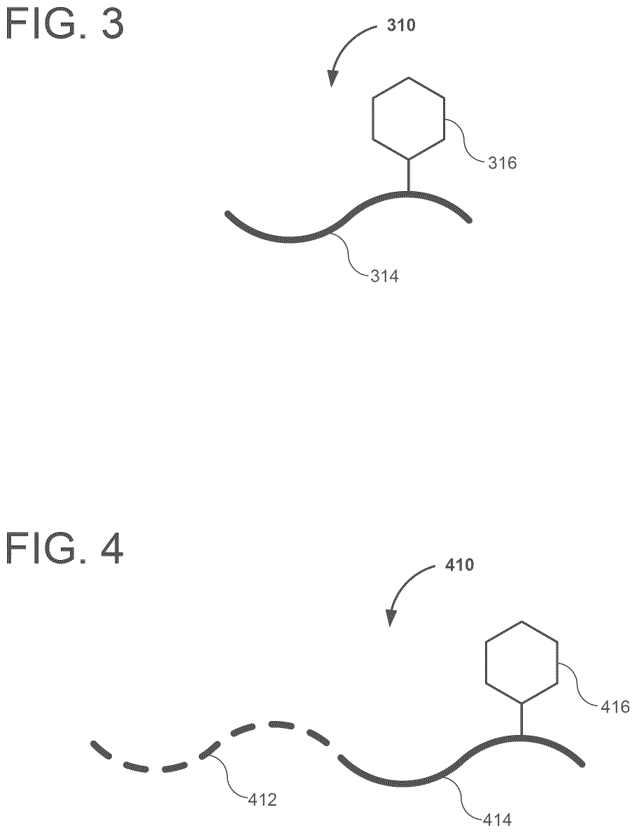

FIG. 3 is a schematic illustration of a binder 310, according to an embodiment. As shown, the binder 310 includes a linear portion 314. The binder 310 further includes a functional portion 316 coupled (e.g., linked, bonded, covalently bonded) to the linear portion 314.

In some embodiments, the binder 310, the linear portion 314, and/or the functional portion 316 may be the same as, or substantially similar to, the binder 10, the second portion 14 (or the first portion 12), and/or the functional portion 16, respectively, as previously described with respect to FIG. 1. Likewise, in some embodiments, the binder 310, the linear portion 314, and/or the functional portion 316 may be the same as, or substantially similar to, the binder 110, the second portion 114 (or the first portion 112), and/or the functional portion 116, respectively, as described with respect to FIG. 2. Therefore, certain features of the binder 310, the linear portion 314, and/or the functional portion 316 are not described in further detail herein.

The linear portion 314 may be a polymer may include, or be formed of, at least one of a polymer (i.e., polymeric material), an oligomer, a monomer, or a combination thereof. In some embodiments, the linear portion 314 may include, or be formed substantially of, a polymer, such as an amorphous polymer or a crystalline polymer. In some embodiments, the linear portion 314 may include, or be formed substantially of, a homopolymer or one or more copolymer(s). For example, in some embodiments, the linear portion 314 may include, or be, a copolymer, such as an alternating copolymer or a block copolymer.

In some embodiments, the linear portion 314 may be “rubbery” or “soft”, and may have a T_{g}≤0° C. In some embodiments, the linear portion 314 may be configured to impart flexibility to the binder 310. In some embodiments, the linear portion 314 may be, or include portions that are, substantially non-polar. In some embodiments in which the linear portion 312 is non-polar or includes portions that are substantially non-polar, the linear portion 314 and/or the binder 310 may be compatible with (i.e., dissolvable in) non-polar solvents. Non-polar solvents may include, but are not limited to, at least one of toluene, anisole, xylene, or isobutyl isobutyrate.

In some embodiments, the linear portion 314 may be “glassy” or “hard”, and may have a T_{g}≥50° C. In some embodiments, the linear portion 314 may be configured to impart binding capability to the binder 310. In some embodiments, the linear portion 314 may be configured to enable functionalization of the binder 310. In some embodiments, the linear portion 314 may be polar, or may include a portion that is polar. Without being bound by theory, this may, for example, enable improved binding, adhesion, or interaction with silicon (Si) materials (e.g., the silicon (Si) materials as described with respect to FIG. 2 and that may be included in an anode, cathode, or separator of an electrochemical cell) as the silicon (Si) material may include a polar surface, and the linear portion 314 that is polar (or includes a portion that is polar) may couple to the polar surface of the silicon (Si) material.

Although FIG. 3 displays a single linear portion 314 and a single functional portion 316, in some embodiments one or more linear portions and/or one or more functional portions may be incorporated into the binder 310. For example, FIG. 4 is a schematic illustration of a binder 410 including a first portion 412 and a second portion 414 coupled at corresponding axial ends to yield a linear structure, according to an embodiment. The binder 410 includes a functional portion 416 coupled to thereto.

In some embodiments, the binder 410, the first portion 412, the second portion 414, and/or the functional portion 416 may be the same as, or substantially similar to, the binder 10, the first portion 12, the second portion 14, and/or the functional portion 16, respectively, as previously described with respect to FIG. 1. Likewise, in some embodiments, the binder 410, the first portion 412, the second portion 414, and/or the functional portion 416 may be the same as, or substantially similar to, the binder 110, the first portion 112, the second portion 114, and/or the functional portion 116, respectively, as described with respect to FIG. 2. Furthermore, in some embodiments, the binder 410, the first portion 412, the second portion 414, and/or the functional portion 416 may be the same as, or substantially similar to, the binder 310, the linear portion 314, and/or the functional portion 316, respectively, as described with respect to FIG. 3. Therefore, certain features of the binder 410, the first portion 412, the second portion 414, and/or the functional portion 416 are not described in further detail herein.

In some embodiments, the binder 410 may include, or be formed substantially of, linear polymers and/or linear copolymers, the linear polymers or linear copolymers having a linear structure including a main chain (i.e., main polymer chain or “polymer backbone”). In some embodiments, the first portion 412 and/or the second portions 414 may each include, or be formed substantially of, homopolymers or copolymers, each of which may be linear. In some embodiments, the linear copolymers forming the binder 410 may include the first portion 412 and/or the second portion 414. In some embodiments, the first portion 412 may include, or be formed substantially of, a first polymer, and the second portion 414 may include, or be formed substantially of, a second polymer. In some embodiments, the second polymer may be different from the first polymer. For example, the first portions 412 and the second portions 414 may be disposed in, incorporated in, or may substantially form, the main chain of the linear copolymer. In some embodiments, the binder 410 may include at least one of alternating copolymers including or formed of the first portion 412 and the second portion 414, random or statistical copolymers including or formed of the first portion 412 and the second portion 414, or block copolymers including or formed of the first portion 412 and the second portion 414. For example, in some embodiments, the first portion 412 and the second portion 414 may be alternating with one another in the main chain. In some embodiments, the first portions 412 and the second portions 414 may be disposed randomly or statistically in the main chain of the binder 410. In some embodiments, a plurality of the first polymers may be coupled together in the first portion 412 such that the first portion 412 may form a first block, and a plurality of the second polymers may be coupled together in the second portion 414 such that the second portion 414 forms a second block, such that the first portion 412 (i.e., first block) and the second portion 414 (i.e., second block) may form a block copolymer, for example the main polymer chain of the block copolymer. In some embodiments, the binder 410 including, or formed substantially of, the linear polymer or linear copolymers may be referred to as “linear copolymeric binder 410.”

In some embodiments, the functional portion 416 is coupled to the second portion 414, for example, as shown in FIG. 4. In some embodiments, the functional portion 416 may be coupled to the first portion 412. In some embodiments, the binder 410 may include a plurality of functional portions, each of which may be the same as, or substantially similar to, the functional portion 416, and, hence, the plurality of functional portions may be referred to herein as “functional portion(s) 416.” In some embodiments, the binder 410 may include multiple functional portions 416. For example, in some embodiments, the second portion 414 may include one or more functional portion(s) 416. In some embodiments, the first portion 412 may include one or more functional portion(s) 416. In some embodiments, the first portion 412 and the second portion 414 may each include one or more functional portion(s) 416.

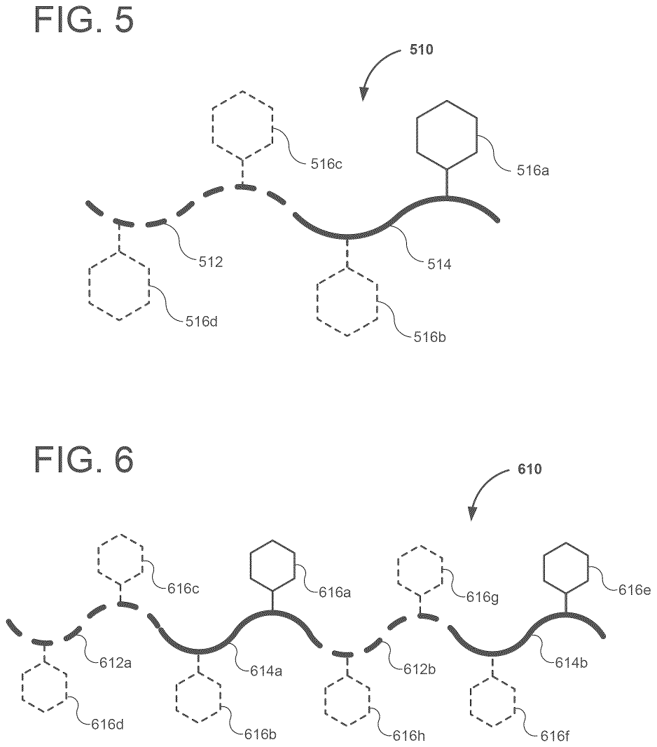

For example, FIG. 5 is a schematic illustration of a binder 510 including a first portion 512 and a second portion 514 coupled in a linear structure, a first functional portion 516a, and optionally, a second functional portion 516b, a third functional portion 516c, and/or a fourth functional portion 516d (collectively referred to herein as “functional portion(s) 516”), according to an embodiment.

In some embodiments, the binder 510, the first portion 512, the second portion 514, and/or the functional portion(s) 516 may be the same as, or substantially similar to, the binder 10, the first portion 12, the second portion 14, and/or the functional portion 16, respectively, as previously described with respect to FIG. 1. Likewise, in some embodiments, the binder 510, the first portion 512, the second portion 514, and/or the functional portion(s) 516 may be the same as, or substantially similar to, the binder 110, the first portion 112, the second portion 114, and/or the functional portion 116, respectively, as described with respect to FIG. 2. Moreover, in some embodiments, the binder 510, the first portion 512, the second portion 514, and/or the functional portion 516 may be the same as, or substantially similar to, the binder 310, the linear portion 314, and/or the functional portion 316, respectively, as described with respect to FIG. 3. Furthermore, in some embodiments, the binder 510, the first portion 512, the second portion 514, and/or the functional portion(s) 516 may be the same as, or substantially similar to, the binder 410, the first portion 412, the second portion 414, and/or the functional portion 416, respectively, as described with respect to FIG. 4. Therefore, certain features of the binder 510, the first portion 512, the second portion 514, and/or the functional portion(s) 516 are not described in further detail herein.

In some embodiments, the binder 510 may include a single functional portion 516, or optionally, two functional portions 516, three functional portions 516, or four functional portions 516, as shown in FIG. 5. In some embodiments, the binder 510 may include greater numbers of functional portion(s) 516. For example, in some embodiments, the binder 510 may include at least about 1, at least about 2, at least about 3, at least about 4, at least about 5, at least about 6, at least about 7, at least about 8, at least about 9, at least about 10, at least about 11, at least about 12, at least about 13, at least about 14, at least about 15, at least about 16, at least about 17, at least about 18, at least about 19, at least about 20, or even greater numbers of functional portion(s) 516, for example, in a given length of the binder 510. In some embodiments, the binder 510 may include no more than about 20, no more than about 19, no more than about 18, no more than about 17, no more than about 16, no more than about 15, no more than about 14, no more than about 13, no more than about 12, no more than about 10, no more than about 9, no more than about 8, no more than about 7, no more than about 6, no more than about 5, no more than about 4, no more than about 3, or no more than about 2 functional portion(s) 516, for example, in the given length of the binder 510. Including greater numbers of functional portion(s) 516 in the binder 510 may, for example, help improve dispersion of conductive materials (e.g., conductive materials as described with respect to FIG. 2) and/or active electrode materials (e.g., active materials of anode 130 or cathode 150 as described with respect to FIG. 2), which may enable electrochemical cells (e.g., electrochemical cell 100 as described with respect to FIG. 2) with greater cyclability, specific capacity, rate capabilities (e.g., improved charge rates or discharge rates), or other benefits as described herein over electrochemical cells with fewer functional portions or no functional portions.

In some embodiments, one or more functional portion(s) 516 may be coupled to at least one of the second portion 514 and/or the first portion 512. For example, in some embodiments, one or more functional portion(s) 516 may be coupled to the second portion 514. In some embodiments, one or more functional portion(s) 516 may be coupled to the first portion 512. In some embodiments, one or more functional portion(s) 516 may be coupled to both the first portion 512 and the second portion 514. In some embodiments, the functional portion(s) 516 are only coupled to the second portion 514.

Although FIG. 5 only shows a singular first portion 512 and a singular second portion 514, in some embodiments, the binder 510 may include a plurality of first portions and/or a plurality of second portions. For example, FIG. 6 is a schematic illustration of a binder 610 including a plurality of first portions 612a, 612b (collectively referred to herein as “first portions 612”), a plurality of second portions 614a, 614b (collectively referred to herein as “second portions 614”) coupled in a linear chain, according to an embodiment. In some embodiments, the binder 610 may include a plurality of functional portions 616a, 616b, 616c, 616d, 616e, 616f, 616g, and/or 616h (collectively referred to herein as “functional portions 616”).

In some embodiments, the binder 610, the first portions 612, the second portions 614, and/or the functional portions 616 may be the same as, or substantially similar to, the binder 510, the first portion 512, the second portion 514, and/or the functional portion(s) 516, respectively, as described with respect to FIG. 5. Therefore, certain features of the binder 610, the first portions 612, the second portions 614, and/or the functional portions 616 are not described herein.

In some embodiments, the first portions 612 and/or the second portions 614 may each be homopolymers or copolymers. In some embodiments, the binder 610 may include, or be formed substantially of, linear polymers and/or linear copolymers, the linear polymers or linear copolymers having a linear structure including a main chain (i.e., main polymer chain or “polymer backbone”). The linear polymers or linear copolymers may include the first portions 612 and/or the second portions 614. For example, the first portions 612 and the second portions 614 may be disposed in, incorporated in, or may substantially form, the main chain of the linear copolymer. In some embodiments, the binder 610 may include at least one of alternating copolymers including the first portion(s) 12 and the second portion(s) 14, random or statistical copolymers including the first portion(s) 12 and the second portion(s) 14, or block copolymers including the first portion(s) 12 and the second portion(s) 614. For example, in some embodiments, the first portion(s) 612 and the second portion(s) 614 may be alternating with one another in the main chain. In some embodiments, the first portions 612 and the second portions 614 may be disposed randomly or statistically in the main chain of the binder 610. In some embodiments, the first portions 612 may be coupled together to form a first block of first portions 612 and/or the second portions 614 may be coupled together to form a second block of second portion 614, and the first block and second block may be disposed in the main polymer chain to form the block copolymer. In some embodiments, the binder 610 including, or formed substantially of, the linear polymer or linear copolymers may be referred to as “linear copolymeric binder 610.”

In some embodiments, each of the first portions 612 and/or the second portions 614 may have corresponding axial ends. In some embodiments, the axial ends may be configured to couple (e.g., bond, covalently bond, pi-bond, etc.) to subsequent first portions 612 and/or subsequent second portions 614. In some embodiments, the axial ends may also be uncoupled.

In some embodiments, a first axial end or a second axial end of at least one of the first portions 612 (e.g., 612a, 612b) may be coupled (e.g., bonded, covalently bonded) to a first axial end or a second axial end of at least one of the second portions 614 (e.g., 614a, 614b) to form the linear chain. For example, as shown in FIG. 6, the first portion 612a has a first axial end and a second axial end. In some embodiments, the first axial end of the first portion 612a may be uncoupled. In some embodiments, the second axial end of the first portion 612a may be coupled to a first axial end of the second portion 614a. In some embodiments, a second axial end of the second portion 614 may be coupled to a first axial end of the first portion 612b. In some embodiments, a second axial end of the first portion 612b may be coupled to a first axial end of the second portion 614b. In some embodiments, the second portion 614b has a second end that is uncoupled. In some embodiments, the second axial end of the second portion 614b may be coupled to a first axial end or a second axial end of further first portions 612 or further second portions 614 to further extend the linear chain. Likewise, in some embodiments, the first axial end of the first portion 612a may be coupled to a first axial end or a second axial end of further first portions 612 or further second portions 614 to further extend the linear chain.

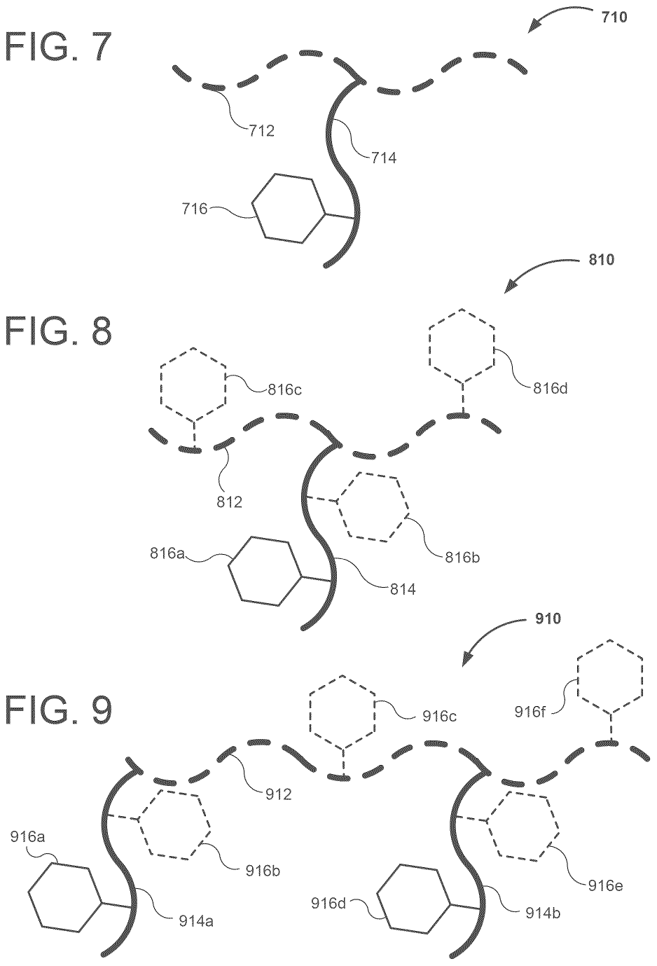

FIG. 7 is a schematic illustration of a binder 710 including a first portion 712 and a second portion 714 coupled in a grafted (or “branched”) structure, according to an embodiment. In some embodiments, the binder 710 further includes a functional portion 716.

In some embodiments, the binder 710, the first portion 712, the second portion 714, and/or the functional portion 716 may be the same as, or substantially similar to, the binder 10, the first portion 12, the second portion 14, and/or the functional portion 16, respectively, as previously described with respect to FIG. 1. Likewise, in some embodiments, the binder 710, the first portion 712, the second portion 714, and/or the functional portion 716 may be the same as, or substantially similar to, the binder 110, the first portion 112, the second portion 114, and/or the functional portion 116, respectively, as described with respect to FIG. 2. Furthermore, in some embodiments, the binder 710, the first portion 712, the second portion 714, and/or the functional portion 416 may be the same as, or substantially similar to, the binder 310, the linear portion 314, and/or the functional portion 316, respectively, as described with respect to FIG. 3. Therefore, certain features of the binder 710, the first portion 712, the second portion 714, and/or the functional portion 716 are not described in further detail herein.

In some embodiments, the first portion 712 may form a main chain (or polymer backbone), and the second portion 714 may form a side chain, as shown in FIG. 7. In some embodiments, the second portion 714 may be coupled at a predetermined location (e.g., position) along a length of the first portion 712. For example, in some embodiments, the second portion 714 may be coupled to the first portion 712 proximate a center (e.g., middle, mid-point) of the length of the first portion 712. In some embodiments, the second portion 714 may be coupled to the first portion 712 at a location offset from the center of the length of the first portion 712. In some embodiments, the second portion 714 may be coupled to the first portion 712 proximate a first axial end or a second axial end of the first portion 712. In some embodiments, the second portion 714 may be coupled to the first portion 712 at a location approximately equidistant between the first axial end and the second axial end of the first portion 712. In some embodiments, the second portion 714 may be coupled to any suitable location or position along the length of the first portion 712.

In some embodiments, the functional portion 716 is coupled to the second portion 714, for example, as shown in FIG. 7. In some embodiments, the functional portion 716 may be coupled to the first portion 712. In some embodiments, the binder 710 may include a plurality of functional portions, each of which may be the same as, or substantially similar to, the functional portion 716, and, hence, the plurality of functional portions may be referred to herein as “functional portion(s) 716.” In some embodiments, the binder 710 may include multiple functional portions 716. For example, in some embodiments, the second portion 714 may include one or more functional portion(s) 716. In some embodiments, the first portion 712 may include one or more functional portion(s) 716.

In some embodiments, the first portion 712 and the second portion 714 may each include one or more functional portion(s) 716. For example, FIG. 8 is a schematic illustration of a binder 810 including a first portion 812 and a second portion 814 coupled in a grafted (or “branched”) structure, a first functional portion 816a, and optionally, a second functional portion 816b, a third functional portion 816c, and/or a fourth functional portion 816d (collectively referred to herein as “functional portion(s) 816”), according to an embodiment.

In some embodiments, the binder 810, the first portion 812, the second portion 814, and/or the functional portion(s) 816 may be the same as, or substantially similar to, the binder 10, the first portion 12, the second portion 14, and/or the functional portion 16, respectively, as previously described with respect to FIG. 1. Likewise, in some embodiments, the binder 810, the first portion 812, the second portion 814, and/or the functional portion(s) 816 may be the same as, or substantially similar to, the binder 110, the first portion 112, the second portion 114, and/or the functional portion 116, respectively, as described with respect to FIG. 2. Furthermore, in some embodiments, the binder 810, the first portion 812 (or the second portion 814), and/or the functional portion(s) 816 may be the same as, or substantially similar to, the binder 310, the linear portion 314, and/or the functional portion 316, respectively, as described with respect to FIG. 3. Moreover, in some embodiments, the binder 810, the first portion 812, the second portion 814, and/or the functional portion(s) 816 may be the same as, or substantially similar to, the binder 710, the first portion 712, the second portion 714, and/or the functional portion 716, respectively, as previously described with respect to FIG. 7. Therefore, certain features of the binder 810, the first portion 812, the second portion 814, and/or the functional portion(s) 816 are not described in further detail herein.

In some embodiments, the binder 810 may include a single functional portion 816, or optionally, two functional portions 816, three functional portions 816, or four functional portions 816, as shown in FIG. 8. In some embodiments, the binder 810 may include greater numbers of functional portions 816. For example, in some embodiments, the binder 810 may include at least about 1, at least about 2, at least about 3, at least about 4, at least about 5, at least about 6, at least about 7, at least about 8, at least about 9, at least about 10, at least about 11, at least about 12, at least about 13, at least about 14, at least about 15, at least about 16, at least about 17, at least about 18, at least about 19, at least about 20, or even greater numbers of functional portion(s) 816, for example, in a given length of the binder 810 or a given length of the first portion 812. In some embodiments, the binder 810 may include no more than about 20, no more than about 19, no more than about 18, no more than about 17, no more than about 16, no more than about 15, no more than about 14, no more than about 13, no more than about 12, no more than about 10, no more than about 9, no more than about 8, no more than about 7, no more than about 6, no more than about 5, no more than about 4, no more than about 3, or no more than about 2 functional portion(s) 816, for example, in the given length of the binder 810 or the given length of the first portion 812. Including greater numbers of functional portion(s) 816 in the binder 810 may, for example, help improve dispersion of conductive materials (e.g., conductive materials as described with respect to FIG. 2) and/or active electrode materials (e.g., active materials of anode 130 or cathode 150 as described with respect to FIG. 2), which may enable electrochemical cells (e.g., electrochemical cell 100 as described with respect to FIG. 2) with improved cyclability, specific capacity, rate capabilities (e.g., improved charge rates or discharge rates), or other benefits as described herein over electrochemical cells with fewer functional portions or no functional portions.

In some embodiments, one or more functional portion(s) 816 may be coupled to at least one of the second portion 814 and/or the first portion 812. For example, in some embodiments, one or more functional portion(s) 816 may be coupled to the second portion 814. In some embodiments, one or more functional portion(s) 816 may be coupled to the first portion 812. In some embodiments, one or more functional portion(s) 816 may be coupled to both the first portion 812 and the second portion 814. In some embodiments, the functional portion(s) 816 are only coupled to the second portion 814.

Although FIG. 8 only shows a singular first portion 812 and a singular second portion 814, in some embodiments, the binder 810 may include a plurality of first portions and/or a plurality of second portions. For example, FIG. 9 is a schematic illustration of a binder 910 including a first portion 912 forming a long chain, a plurality of second portions 914a, 914b (collectively referred to herein as “second portions 914”) coupled in a grafted (or “branched”) structure, according to an embodiment. In some embodiments, the binder 910 may include a plurality of functional portions 916a, 916b, 916c, 916d, 916e, and/or 916f (collectively referred to herein as “functional portions 916”).

In some embodiments, the binder 910, the first portion 912, the second portions 914, and/or the functional portions 916 may be the same as, or substantially similar to, the binder 10, the first portion 12, the second portion 14, and/or the functional portion 16, respectively, as previously described with respect to FIG. 1. Likewise, in some embodiments, the binder 910, the first portion 912, the second portions 914, and/or the functional portion(s) 916 may be the same as, or substantially similar to, the binder 110, the first portion 112, the second portion 114, and/or the functional portion 116, respectively, as described with respect to FIG. 2. Furthermore, in some embodiments, the binder 910, the first portion 912 (or the second portions 914), and/or the functional portion(s) 916 may be the same as, or substantially similar to, the binder 310, the linear portion 314, and/or the functional portion 316, respectively, as described with respect to FIG. 3. Moreover, in some embodiments, the binder 910, the first portion 912, the second portions 914, and/or the functional portions 916 may be the same as, or substantially similar to, the binder 710, the first portion 712, the second portion 714, and/or the functional portion 716, respectively, as previously described with respect to FIG. 7. Additionally, in some embodiments, the binder 910, the first portion 912, the second portions 914, and/or the functional portions 916 may be the same as, or substantially similar to, the binder 810, the first portion 812, the second portion 814, and/or the functional portion(s) 816, respectively, as previously described with respect to FIG. 8. Therefore, certain features of the binder 910, the first portion 912, the second portion 914, and/or the functional portion(s) 916 are not described in further detail herein.

In some embodiments, the binder 910 may include, or be formed substantially of, branched polymers or branched copolymers, the branched polymers or branched copolymers having a main chain (i.e., main polymer chain or “polymer backbone”) with one or more side chains (e.g., polymeric side chains), extending therefrom. For example, in some embodiments, the first portion 912 forms the main chain, and the second portions 914 extend as side chains from the first portion 912, as shown. In this manner, the first portion 912 and the second portion(s) 914 may form the grafted (or branched) structure. Therefore, in some embodiments, the binder 910 may be referred to as “branched copolymeric binder 910.”

In some embodiments, the first portion 912 may include, or be formed substantially of, a plurality of first portions forming a long polymer chain, each of which may be the same as, or substantially similar to, the first portion 912, and hence, may be collectively referred to herein as “first portion(s) 912.” In some embodiments, each of the first portion(s) 912 may have corresponding axial ends. In some embodiments, the first portion(s) 912 may be configured to be coupled, or may be coupled, to other (or subsequent) first portion(s) 912 via the corresponding axial ends. For example, in some embodiments, each of the first portion(s) 912 may have a first axial end and a second axial end. In some embodiments, the first axial end and/or the second axial end of the first portion(s) 912 may be configured to be coupled, or may be coupled, to the first axial end and/or the second axial end subsequent first portion(s) 912 to form the long polymer chain.

In some embodiments, the second portion(s) 914 may be coupled to the first portion(s) 912 (i.e., the long polymer chain) as a plurality of side chains, as shown. In some embodiments, the second portion(s) 914 may be coupled at a predetermined location(s) (e.g., position) along a length of the first portion(s) 912. In some embodiments, the second portion(s) 914 may be coupled proximate the first axial end and/or the second axial of the first portion(s) 912. For example, as shown in FIG. 9, second portion 914a may be coupled proximate the axial end of the first portion 912. In some embodiments, the second portion(s) 914 may be coupled to the first portion(s) 912 proximate a center (e.g., middle, mid-point) of the length of the first portion(s) 912. In other words, in some embodiments, the second portion(s) 914 may be coupled to the first portion(s) 912 at a location approximately equidistant between the first axial end and the second axial end of the first portion(s) 912. In some embodiments, the second portion 914 may be coupled to the first portion 712 at a location offset from the center of the length of the first portion(s) 912, and/or at a location offset from the axial ends of the first portion(s) 912. For example, as shown in FIG. 9, second portion 914b may be coupled to the first portion(s) 912 at a location offset from the center of the first portion(s) 912 and/or offset from the axial ends of the first portion(s) 912. In some embodiments, the second portion(s) 914 may be coupled to any suitable location or position along the length of the first portion(s) 912.

Although FIG. 9 only shows two second portion(s) 914, in some embodiments, the binder 910 may include even greater numbers of second portion(s) 914, for example, coupled as side chains to the first portion(s) 912. For example, in some embodiments, the binder 910 may include at least about 2, at least about 3, at least about 4, at least about 5, at least about 6, at least about 7, at least about 8, at least about 9, at least about 10, at least about 11, at least about 12, at least about 13, at least about 14, at least about 15, at least about 16, at least about 17, at least about 18, at least about 19, at least about 20, or even greater numbers of second portion(s) 914, for example, in a given length of the binder 910 or a given length of the first portion(s) 912. In some embodiments, the binder 910 may include no more than about 20, no more than about 19, no more than about 18, no more than about 17, no more than about 16, no more than about 15, no more than about 14, no more than about 13, no more than about 12, no more than about 10, no more than about 9, no more than about 8, no more than about 7, no more than about 6, no more than about 5, no more than about 4, no more than about 3, or no more than about 2 second portion(s) 914, for example, in the given length of the binder 910 or the given length of the first portion(s) 912.

Including greater numbers of second portion(s) 914 in the binder 910 along the length of the first portion(s) 912 may, for example, enable greater numbers of functional portion(s) 916 in the binder, which may help improve dispersion of conductive materials (e.g., conductive materials as described with respect to FIG. 2) and/or active electrode materials (e.g., active materials of anode 130 or cathode 150 as described with respect to FIG. 2). This may, for example, enable electrochemical cells (e.g., electrochemical cell 100 as described with respect to FIG. 2) with improved cyclability, specific capacity, rate capabilities (e.g., improved charge rates or discharge rates), or other benefits as described herein over electrochemical cells with fewer functional portions or no functional portions. Furthermore, including greater numbers of second portion(s) may also increase a molecular weight (Mₙ) of the binder 910 and/or improve a viscosity of a slurry including the binder 910, for example, during casting of the electrode materials including the binder 910. The numbers of second portion(s) 914 may be selected to selectively adjust the molecular weight of the binder 910 and/or the viscosity of the slurry including the binder 910 to suitable levels for improved manufacturability of the binder 910, the slurries including the binder 910, and/or the electrochemical cells including the binder 910 (e.g., electrochemical cell 100).

In some embodiments, one or more functional portion(s) 916 may be coupled to at least one of the second portion(s) 914 and/or the first portion 912. In some embodiments, one or more functional portion(s) 916 may be coupled to the second portion(s) 914, as shown in FIG. 9. For example, in some embodiments, functional portion 916a, and, optionally, functional portion 916b, may be coupled to the second portion 914a. Likewise, in some embodiments, functional portion 916d, and, optionally, functional portion 916e, may be coupled to the second portion 914b. In some embodiments, one or more functional portion(s) 916 may be coupled to the first portion 912. For example, in some embodiments, the functional portion 916c and/or the functional portion 916f may optionally be coupled to the first portion 912. In some embodiments, one or more functional portion(s) 916 may be coupled to both the first portion 912 and the second portion(s) 914. In some embodiments, the functional portion(s) 916 are only coupled to the second portion(s) 914.

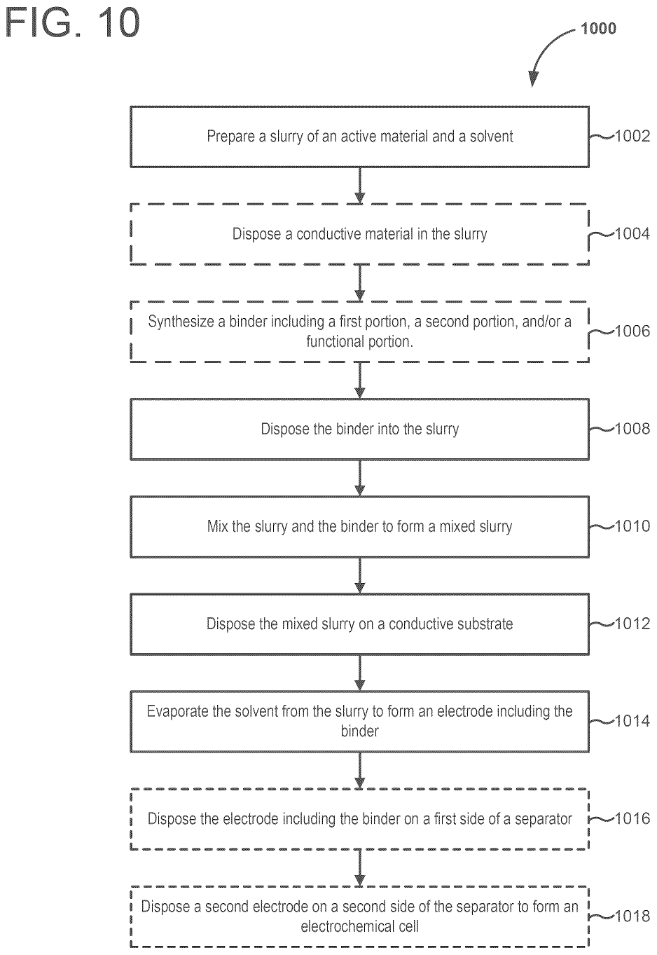

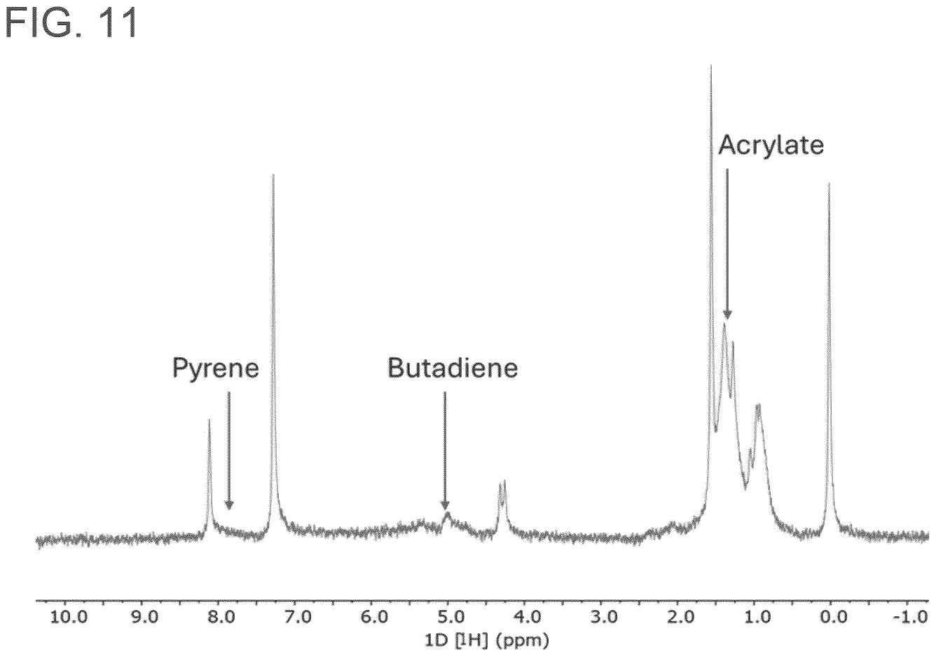

FIG. 10 is a schematic flow chart of a method 1000 for preparing an electrochemical cell (e.g., electrochemical cell 100 of FIG. 2), including a binder (e.g., binder 10, 110, 310, 410, 510, 610, 710, 810, 910), according to an embodiment. While described with respect to the electrochemical cell 100 and binder 110 of FIG. 2, the method 1000 is equally applicable to any of the electrochemical cells described herein including any of the binders (e.g., binders 10, 310, 410, 510, 610, 710, 810, 910) described herein. All such variations should be considered to be within the scope of this disclosure.

The method 1000 includes preparing a slurry of an active material and a solvent, at 1002. The active material may include any of the active materials of the electrochemical cell 100 (e.g., anode active material of the anode 130, cathode active material of the cathode 150), as described with respect to FIG. 2. In some embodiments, the method may include mixing the active material and the solvent to form the slurry. In some embodiments, the solvent may be non-polar, or substantially non-polar, as described with respect to FIG. 2. In some embodiments, the method 1000 may further include disposing a conductive material (e.g., a carbonaceous material) in the slurry, at 1004. The conductive material may be any of the conductive materials (e.g., anode conductive material of anode 130, cathode conductive material of cathode 150), for example, as described herein with respect to FIG. 2.

In some embodiments, the method 1000 may further include synthesizing the binder 110 including the first portion 112, the second portion 114, and/or a functional portion 116, at 1006. As previously described, the first portion 112 may have a first T_{g}, and the second portion 114 may have a second T_{g}. In some embodiments, the first T_{g} may be less than the second T_{g}. In some embodiments, the first T_{g} (i.e., T_{g} of the first portion 112) may be equal to or less than about 0° C. In some embodiments, the second T_{g} (i.e., T_{g} of the second portion 114) may be equal to or greater than about 50° C. In some embodiments, the binder 110 may be a linear copolymeric binder (e.g., alternating copolymer, random or statistical copolymer, block copolymer, etc.), for example, having first portion(s) 112 and second portion(s) 114 disposed in, or forming, a linear chain. In some embodiments, the binder 110 may be a grafted (or branched) copolymeric binder, for example, having first portion(s) 112 forming a main chain, and second portion(s) 114 coupled as side chain(s) to the first portion(s) 112. In some embodiments, the binder 110 may be synthesized with non-polar, or substantially non-polar, solvents.

The method 1000 further includes disposing the binder 110 including the first portion(s) 112, the second portion(s) 114, and/or the functional portion(s) 116 into the slurry, at 1008. The method further includes mixing the slurry including the binder 110 to form a mixed slurry, at 1010. The slurry may be mixed via any mixer suitable for mixing slurries of electrode materials (e.g., active materials, conductive materials, and/or binders), solid-state electrolyte slurries, and/or any mixer suitable for slurries for electrochemical cells. For example, the slurry including the binder 110 may be mixed via a planetary centrifugal mixer, such as a THINKY™ mixer, at any RPM, orientation, shear force, or other parameters suitable for mixing slurries of electrode materials, solid-state electrolyte slurries, and/or slurries for electrochemical cells (e.g., electrochemical cell 100). In some embodiments, the slurry may be mixed at, or near, atmospheric pressure. In some embodiments, the slurry may be mixed under reduced-pressure conditions. In some embodiments, the slurry may be mixed in a low pressure environment, for example, a vacuum environment or under vacuum, for example, to eliminate air bubbles from the slurry. In some embodiments, the slurry may be mixed at, or near, standard temperature and pressure (STP) conditions as defined by International Union of Pure and Applied Chemistry (IUPAC) [i.e., at or near a temperature of about 0° C. and a pressure of about 1 atm (i.e., about 101.325 kPa)]. In some embodiments, the slurry may be mixed at, or near, standard temperature and pressure (STP) conditions as defined by National Institute of Standards and Technology (NIST) [i.e., at or near a temperature of about 20° C. and a pressure of about 1 atm (i.e., about 101.325 kPa)]. In some embodiments, the slurry may be mixed at temperatures below 0° C. In some embodiments, the slurry may be mixed at elevated temperature, e.g., at temperatures above 20° C.

The method 1000 further includes disposing the mixed slurry including the binder 110 on a conductive substrate, at 1012. In some embodiments, the conductive substrate may include, or be, any of the current collectors (e.g., anode current collector 120, cathode current collector 140) as described with respect to FIG. 2.

The method 1000 further includes evaporating the solvent from the slurry to form an electrode (e.g., anode 130, cathode 150) including the binder 110, at 1014. The solvent may be evaporated from the slurry to from the electrode via any suitable means, for example, via a heater. The solvent may be heated at elevated temperatures (e.g., temperatures greater than about 20° C.) to prepare the electrode. In some embodiments, heating may pre-cure or cure the binder 110.

In some embodiments, the method 1000 may further include disposing the electrode (e.g., anode 130, cathode 150) including the binder 110 on a first side of the separator 160, at 1016. In some embodiments, the separator 160 may include, or be formed substantially of, a solid-state electrolyte, as previously described with respect to FIG. 2. In some embodiments, the separator 160 may also include the binder 110. In some embodiments, the electrode may be a first electrode (e.g., anode 130, cathode 150), and the method 1000 may further include disposing a second electrode (e.g., cathode 150, anode 130) on a second side of the separator 160 to form the electrochemical cell 100, at 1018. In some embodiments, the first electrode (e.g., anode 130, cathode 150) and/or second electrode (e.g., cathode 150, anode 130) may each be on a corresponding current collector (e.g., anode current collector 120, cathode current collector 140). In some embodiments, the second electrode may be prepared via the same, or substantially similar, operations as the first electrode. For example, in some embodiments, the second electrode may be prepared via operations 1002, 1004, 1006, 1008, 1010, 1012, and/or 1014. In some embodiments, the second electrode may additionally, or alternatively include the binder 110.

Although FIG. 10 illustrates an example of the method 1000 including 1002, 1004, 1006, 1008, 1010, 1012, 1014, 1016, and/or 1018 in sequential order, in some embodiments, the method 1000 may exclude, replace, or reorder one or more of the operations. In some embodiments, the operations performed as part of the method 1000 may be ordered in any suitable way. In some embodiments, one or more of the operations 1002, 1004, 1006, 1008, 1010, 1012, 1014, 1016, and/or 1018 may be performed simultaneously or at overlapping times. In some embodiments, a plurality of 1002, 1004, 1006, 1008, 1010, 1012, 1014, 1016, and/or 1018 may be performed simultaneously, or at the same time. All such embodiments are envisioned herein.

Following are some examples of binders according to the embodiments described herein. These examples are for illustrative purposes only and should not be construed as limiting the disclosure.

### EXAMPLE 1: SYNTHESIS AND APPLICATION OF 1,2-POLYBUTADIENE-GRAFT-POLY(ACRYLATE)

Acrylate monomer was purchased from Sigma-Aldrich and passed through a silica gel column to remove the inhibitor. Azobisisobutyronitrile (AIBN) was purchased from Sigma, recrystallized in ethanol at 45° C., and dried prior to use. Thioester chain transfer agent, toluene (anhydrous) and n-butylamine were purchased from Sigma and used without further purification. 1,2-polybutadiene was purchased from Alfa Chemistry with a molecular weight in a range of about 200 kg/mol to about 300 kg/mol. In a dry glass vial, AIBN, chain transfer agent, acrylate monomer, and solvent were added. A stir bar was added, and the vial was sealed with a septum. The reaction mixture was then sparged with Ar for 20 minutes. The reaction was then allowed to stir at 60° C. for 18 hours. After the reaction was completed, n-butylamine was added to the reaction via syringe, and the reaction was allowed to stir for an additional 2 hours. The resulting polymer was then purified by precipitation and dried. The purified and dried polymer was then dissolved in solvent again. A stock solution of 8 wt. % polybutadiene in toluene was prepared in advance and added to the reaction. AIBN and a stir bar were then added, and the reaction was mixed thoroughly by a vortex mixer.

The reaction was then sparged with Ar for 20 minutes and allowed to stir at 60° C. for 18 hours. The resulting polymer was then purified by precipitating in a mixture of methanol:water at a ratio of about 85:15 [volume:volume (v/v) ratio] three times. 1H NMR shows both characteristic peaks from polybutadiene (i.e., 1.45-0.49 ppm, 2.40-1.73 ppm, 5.77-3.96 ppm) and polyacrylate (i.e., 1.55 ppm, s, 9H). This polymer was then dissolved in anisole (a non-polar solvent) to form a binder solution and was used for anode casting. The binder solution, additional solvent, and Si, natural graphite and vapor grown carbon fiber(s) were added to a THINKY™ cup with 4 5 mm ZrO₂ balls and mixed. The mixing was performed at 2,000 rpm for 4 minutes. Additional solvent was added, and the slurry was stirred for an additional 4 minutes. The slurry was then casted onto a substrate by doctor blade technique. The casted slurry was dried and cut into electrodes for battery testing.

### EXAMPLE 2: SYNTHESIS AND APPLICATION OF 1,2-POLYBUTADIENE-GRAFT-POLYACRYLATE WITH PYRENE SIDECHAIN

The pyrene-functionalized acrylate was purchased from Sigma and purified by recrystallizing from ethanol prior to use. The polymer was synthesized by using substantially the same general operations as described with respect to EXAMPLE 1, but a mixture of acrylate and pyrene-functionalized acrylate was used in place of the acrylate of the EXAMPLE 1. FIG. 11 is a 1H NMR plot conducted on the polymer and shows the characteristic peaks for pyrene (e.g., at 8.6-7.41 ppm) as well as characteristic peaks from polybutadiene (i.e., 1.45-0.49 ppm, 2.40-1.73 ppm, 5.77-3.96 ppm) and polyacrylate (i.e., 1.55 ppm, s, 9H). This polymer was then dissolved in anisole to form a binder solution and used for anode casting. The binder solution, additional solvent, and Si, natural graphite and vapor grown carbon fiber(s) were added to a THINKY™ cup with 4 5 mm ZrO₂ balls and mixed. The mixing was performed at 2,000 rpm for 4 minutes. Additional solvent was added, and the slurry was stirred for an additional 4 minutes. The slurry was then casted onto a substrate by doctor blade technique. The casted slurry was dried and cut into electrodes for battery testing.

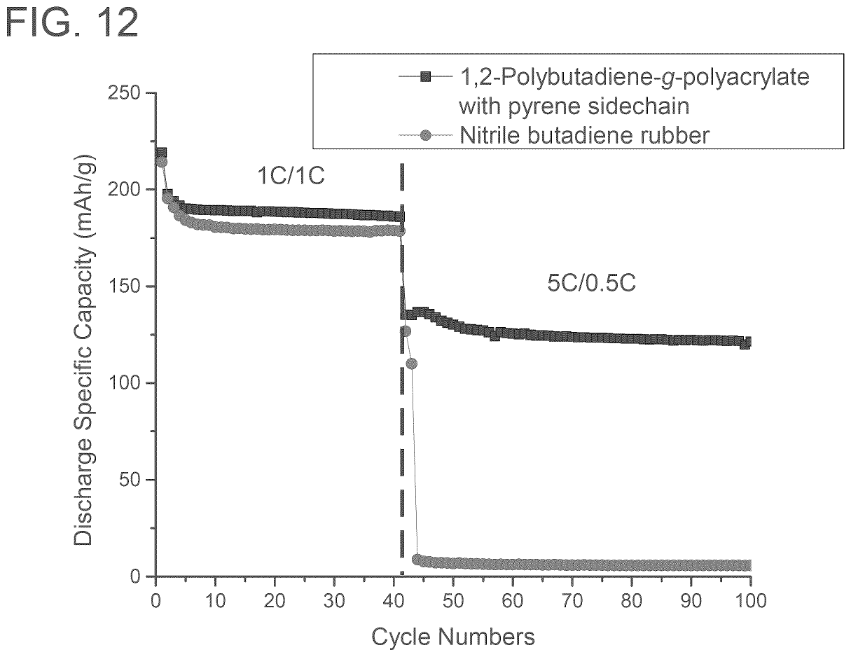

FIG. 12 is a battery cycling plot showing discharge specific capacity (mAh/g) against cycle number for silicon/graphite composite anodes with different binders, with NMC811 as cathode active material. The cathode includes of NMC811:Li₆PS₅Cl:vapor grown carbon fiber (VGCF):polytetrafluoroethylene (PTFE) in a weight ratio of about 85:15:1:1.3. The anode includes silicon:graphite:VGCF:binder in a weight ratio of about 50:50:2.5:2.65. As shown, the plot includes a first curve for a silicon/graphite composite anode having a binder including 1,2-polybutadiene-graft-polyacrylate with pyrene side chains (i.e., referred to as “binder of Example 2”), represented by a black curve with square markers. The plot further includes a second curve for a silicon/graphite composite anode having a commercially available nitrile butadiene (referred to herein as “comparative binder”), represented by a red curve with circle markers. At 1 C/1 C charging/discharging conditions (i.e., cycles 1 to 41) with a cut-off voltage at 2.5 V-4.25 V, the anode including the binder of Example 2 exhibited a slightly higher specific capacity over the anode including the comparative binder for all cycles. For example, the estimated average discharge specific capacity of the anode including the binder of Example 2 was about 185 mAh/g, while the estimated average discharge specific capacity of the anode including the comparative binder was about 177 mAh/g, for cycles 1 to 41.

However, at 5 C/0.5 C charging/discharging conditions (i.e., cycles 42 to 100) with a cut-off voltage at 2.5 V-4.25 V, the anode with the binder of Example 2 exhibited significantly less degradation of discharge specific capacity (i.e., significantly higher discharge specific capacity) than the anode with the comparative binder. As shown, at 5 C/0.5 C charging/discharging conditions, the anode with the binder of Example 2 remained substantially stable throughout cycles 42 to 100 (i.e., maximum of about 135 mAh/g, minimum of about 115 mAh/g, and a percent difference of about 16%) and exhibited an estimated average discharge capacity of about 125 mAh/g. Meanwhile, at 5 C/0.5 C charging/discharging conditions, the anode with the comparative binder exhibited a drastic decrease in discharge specific capacity during the initial cycles at 5 C/0.5 C conditions (e.g., cycles 42 through 44) until stabilizing at an estimated average discharge capacity of about 7 mAh/g. Hence, for cycles 45 through 100 (i.e., cycles after the initial decrease of the anode with the comparative binder), the anode including the binder of Example 2 exhibited an estimated average discharge capacity of about 178% greater than that of the anode with the comparative binder, during 5 C/0.5 C charge/discharge conditions.

### EXAMPLE 3: SYNTHESIS AND APPLICATION OF POLY(METHACRYLATE) WITH PYRENE SIDECHAINS

Methacrylate monomer(s) were purchased from Sigma-Aldrich and passed through a silica gel column to remove the inhibitor. Azobisisobutyronitrile (AIBN) was purchased from Sigma, recrystallized in ethanol at 45° C., and dried prior to use. Thioester chain transfer agent and anisole (anhydrous) were purchased from Sigma and used without further purification. In a dried glass vial, AIBN, thioester chain transfer agent, a first methacrylate monomer, and solvent were added. A stir bar was added, and the vial was sealed with a septum. The reaction mixture was then sparged with Ar for 20 minutes. The reaction was then allowed to stir at 60° C. for 18 hours. The resulting polymer was then purified by precipitation and dried. The purified and dried polymer was then dissolved in solvent again. A second methacrylate monomer, a third methacrylate monomer with pyrene sidechain, solvent, AIBN, and a stir bar were then added, and the reaction was mixed by a vortex mixer until substantially dissolved. The reaction was then sparged with Ar for 20 minutes and allowed to stir at 60° C. for 18 hours. The resulting polymer was then purified by precipitating in a mixture of methanol:water at a ratio of about 85:15 (v/v ratio) three times. 1H NMR indicated both characteristic peaks from pyrene (i.e., 8.6-7.41 ppm) and polymethacrylate (i.e., 3.5 ppm, 1.0-1.5 ppm). This polymer was dissolved in anisole (i.e., a non-polar solvent) to form a binder solution and was used for anode casting. The binder solution, additional solvent, and Si, natural graphite, and vapor grown carbon fibers were added to a THINKY™ cup with ZrO₂ balls and mixed. Additional solvent was added, and the slurry was stirred for an additional 4 minutes. The slurry was then casted onto a substrate by doctor blade technique. The casted slurry was dried and cut into electrodes for battery testing.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell, comprising:
a first electrode disposed on a first current collector;
a second electrode disposed on a second current collector, at least one of the first electrode or the second electrode including at least one of an active material or a conductive material;
a separator disposed between the first electrode and the second electrode, the separator including a solid-state electrolyte; and
a binder included in at least one of the first electrode, the second electrode, or the separator, the binder including:
a first portion having a first glass transition temperature; and
a second portion coupled to the first portion, the second portion having a second glass transition temperature greater than the first glass transition temperature.

2. The electrochemical cell of claim 1, wherein the first portion includes at least one of polybutadiene, polybutadiene derivatives, polyisoprene, polyisoprene derivatives, polydimethylsiloxane, or polydimethylsiloxane derivatives.

3. The electrochemical cell of claim 1, wherein the second portion includes at least one of polymethacrylate, polyacrylate, polystyrene, or polystyrene derivatives.

4. The electrochemical cell of claim 1, wherein the binder further includes:
a functional portion coupled to at least one of the first portion or the second portion.

5. The electrochemical cell of claim 4, wherein the functional portion is coupled only to the second portion.

6. The electrochemical cell of claim 4, wherein the functional portion includes an aromatic or polyaromatic group including at least one of thiophene, thiophene derivatives, biphenyl, biphenyl derivatives, anthracene, anthracene derivatives, fluorene, fluorene derivatives, pyrene, pyrene derivatives, triphenylene, triphenylene derivatives, carbazole, carbazole derivatives, pentacene, or pentacene derivatives.

7. The electrochemical cell of claim 1, wherein an end of the first portion is coupled to an end of the second portion such that the binder has a linear structure.

8. The electrochemical cell of claim 7, wherein the binder further includes:
a functional portion coupled to the second portion.

9. The electrochemical cell of claim 1, wherein the second portion is grafted as a side chain at a predetermined location along a length of the first portion.

10. The electrochemical cell of claim 9, wherein the binder further includes:
a functional portion coupled to the second portion.

11. The electrochemical cell of claim 1, wherein the first glass transition temperature (T_{g}) is equal to or less than about 0° C.

12. The electrochemical cell of claim 1, wherein the second glass transition temperature (T_{g}) is equal to or greater than about 50° C.

13. The electrochemical cell of claim 1, further comprising:
a silicon (Si) material disposed in the active material of the at least one of the first electrode or the second electrode.

14. The electrochemical cell of claim 13, wherein the silicon (Si) material includes at least one of Si particles, Si nanowires, Si nanospheres, Si nanoparticles, Si thin films, porous silicon, silicon monoxide (SiO), silicon oxycarbide, or silicon carbide (Si/C) composites.

15. A binder for an electrochemical cell, the binder comprising:
a first portion having a first glass transition temperature of equal to or less than about 0 degrees Celsius; and
a second portion coupled to the first portion, the second portion having a second glass transition temperature of equal to or greater than about 50 degrees Celsius,
wherein the first portion extends linearly, and the second portion extends as a side chain from at least one predetermined location along a length of the first portion.

16. The binder of claim 15, wherein the first portion includes at least one of polybutadiene, polybutadiene derivatives, polyisoprene, polyisoprene derivatives, polydimethylsiloxane, or polydimethylsiloxane derivatives.

17. The binder of claim 15, wherein the second portion includes at least one of polymethacrylate, polyacrylate, polystyrene, or polystyrene derivatives.

18. The binder of claim 15, further comprising:
a functional portion coupled to at least one of the first portion or the second portion.

19. The binder of claim 18, wherein the functional portion includes at least one of thiophene, thiophene derivatives, biphenyl, biphenyl derivatives, anthracene, anthracene derivatives, fluorene, fluorene derivatives, pyrene, pyrene derivatives, triphenylene, triphenylene derivatives, carbazole, carbazole derivatives, pentacene, or pentacene derivatives.

20. The binder of claim 15, wherein the second portion is grafted to the first portion such that the binder is a graft copolymeric binder.

21. The binder of claim 15, wherein the first glass transition temperature (T_{g}) is in a range of about −180° C. to about 0° C.

22. The binder of claim 15, wherein the second glass transition temperature (T_{g}) is in a range of about 50° C. to about 350° C.

23. The binder of claim 15, wherein a ratio of the second portion to the first portion in the binder is in a range of about 99:1 to about 1:99.

24. A binder for an electrochemical cell, comprising:
a first portion in a range of about 1 wt % to about 99 wt %, the first portion including a first polymer having a glass transition temperature of equal to or less than about 0 degrees Celsius; and
a second portion in a range of about 1 wt % to about 99 wt % mixed with the first polymer, the second portion including a second polymer having a glass transition temperature of equal to or greater than about 50 degrees Celsius, and an aromatic or polyaromatic group coupled to the second portion.

25. The binder of claim 24, wherein the first polymer includes at least one of polybutadiene, polybutadiene derivatives, polyisoprene, polyisoprene derivatives, polydimethylsiloxane, or polydimethylsiloxane derivatives.

26. The binder of claim 24, wherein the second polymer includes at least one of polymethacrylate, polyacrylate, polystyrene, or polystyrene derivatives.

27. The binder of claim 24, wherein the aromatic or polyaromatic group includes at least one of thiophene, thiophene derivatives, biphenyl, biphenyl derivatives, anthracene, anthracene derivatives, fluorene, fluorene derivatives, pyrene, pyrene derivatives, triphenylene, triphenylene derivatives, carbazole, carbazole derivatives, pentacene, or pentacene derivatives.

28. A method, comprising:
mixing an active material, a non-polar solvent, and a binder to form a slurry, the binder including:
a first portion having a first glass transition temperature, and
a second portion coupled to the first portion, the second portion having a second glass transition temperature greater than the first glass transition temperature;
disposing the slurry on a conductive substrate; and
evaporating at least a portion of the non-polar solvent from the slurry to form an electrode.

29. The method of claim 28, wherein the non-polar solvent includes at least one of toluene, anisole, xylene, or isobutyl isobutyrate.

30. The method of claim 28, wherein the electrode is a first electrode, the method further comprising:
disposing the first electrode on a first side of a solid-state electrolyte (SSE) separator; and
disposing a second electrode on a second side of the SSE separator opposite the first side, the second electrode different from the first electrode.
